(19) United States
(12) Patent Application Publication
(10) Pub. No.: US 2026/0007556 A1
(43) Pub. Date: Jan. 8, 2026

(54) MICROCLIMATE MANAGEMENT SYSTEMS

(71) Applicant: UMANO MEDICAL INC., L'Islet (CA)

(72) Inventors: Israël BERNIER, Lévis (CA); Cédric GARCEAU, Shawinigan (CA); Daniel QUINTERO, Québec (CA); Olivier ST-PIERRE, Saint-Michel-de-Bellechasse (CA); Philippe ROY, Québec (CA); Ghislain DEMERS, Beaumont (CA); Simon DUBÉ, Lévis (CA)

(21) Appl. No.: 18/992,873

(22) PCT Filed: Jul. 12, 2023
(86) PCT No.: PCT/IB2023/057163

§ 371 Date: Jan. 9, 2025

Related U.S. Application Data
(60) Provisional application No. 63/388,325, filed on Jul. 12, 2022.

(51) Int. Cl. A61G 7/057

(52) U.S. Cl. CPC A61G 7/05792

(57) ABSTRACT

A microclimate management system for an occupant support is provided with a top layer, an intermediate air diffusion layer operatively interposable between the top layer and the occupant support, and a bottom air distribution manifold extending through the occupant support for distributing air to the intermediate air diffusion layer. There is also provided a microclimate management overlay for an occupant support having a bottom air distribution assembly mountable over the occupant support and configured for circulating air upwardly, an intermediate air diffusion layer operatively mountable above the bottom air distribution assembly for enabling air diffusion from the bottom air distribution assembly, and a top layer mountable above the intermediate air diffusion layer. There is also provided a foam support having a base foam and a seat foam insert that enables pressure redistribution to the base foam. An air pump module is also provided.

### CROSS-REFERENCE

The present application claims benefit to the U.S. Provisional Patent Application Ser. No. 63/388,325 filed on Jul. 12, 2022.

### TECHNICAL FIELD

The present invention generally relates to mattresses and more particularly to microclimate management systems for such mattresses.

### BACKGROUND

Various microclimate management systems, also known as low air loss systems, are usable with various typical mattresses to prevent and treat skin wounds, pressure ulcers, and/or bedsores generally associated with extended bed rest, such as in the case of bedridden patients. Some microclimate management systems attempt to manage or regulate the immediate microenvironment surrounding the occupant by minimizing heat build-up and by wicking away moisture so the occupant skin may remain dry.

Mattresses come in various configurations. For example, non-powered therapeutic mattresses are generally made of foam and/or gel material, while powered therapeutic mattresses are generally made of inflatable bladders powered by a fluid source.

Although various microclimate management systems adapted for various configurations of mattresses have been proposed in the art, there is still a need for a microclimate management system that would offer appropriate performances at an efficient cost.

### SUMMARY

According to a first aspect, there is provided a microclimate management system for an occupant support having an occupant receiving surface. The microclimate management system has a top layer disposable above the occupant receiving surface of the occupant support and an intermediate air diffusion layer operatively interposable between the top layer and the occupant receiving surface of the occupant support. The microclimate management system also has a bottom air distribution manifold mountable with the occupant support and having a plurality of air distribution conduits, each extending at least partially through the occupant support upwardly towards the occupant receiving surface for distributing air to the intermediate air diffusion layer. The plurality of air distribution conduits are arranged according to a predetermined pattern relative to the occupant receiving surface defining a microclimate managed area.

In one embodiment, the top layer is moisture permeable.

In one embodiment, the top layer has a moisture vapor transmission rate between about 50 g/m²/24 hrs and 600 g/m²/24 hrs when measured according to ASTM E96-00.

In one embodiment, the microclimate management system is configured to remove moisture that permeates the top layer.

In one embodiment, air distributed to the intermediate air diffusion layer via the bottom air distribution manifold diffuses throughout the intermediate air diffusion layer.

In one embodiment, the top layer is air permeable.

In one embodiment, a substantial portion of the air distributed to the air distribution conduits is evacuated through the top layer.

In one embodiment, the top layer is non-air permeable.

In one embodiment, the top layer is removably connectable to the occupant support via at least one attachment element.

In one embodiment, a substantial portion of the air distributed to the air distribution conduits is evacuated through the at least one attachment element.

In one embodiment, the microclimate management system is configured to regulate a moisture content in the microclimate managed area.

In one embodiment, the microclimate management system is configured to regulate a temperature in the microclimate managed area.

In one embodiment, the air distribution conduits are arranged in at least two distant groups.

In one embodiment, the at least two distant groups correspond to at least two microclimate managed areas.

In one embodiment, the at least two microclimate managed areas correspond to distinct anatomical regions of the occupant.

In one embodiment, the microclimate management system further comprises a bottom layer removably connectable to the top layer to form a compartment for enclosing the occupant support and the bottom air distribution manifold therein.

In one embodiment, the microclimate management system further comprises a fire-resistant envelope for enclosing the occupant support therein.

In one embodiment, the microclimate management system further comprises a fluid-resistant envelope for enclosing the occupant support therein, the fluid-resistant envelope having a plurality of air circulation apertures, each being operatively connected to a corresponding one of the plurality of air distribution conduits.

In one embodiment, the bottom air distribution manifold comprises an elongated air supply section disposed below the occupant support, the elongated air supply section being operatively connectable to each of the plurality of air distribution conduits.

In one embodiment, the elongated air supply section comprises a three-dimensional spacer extending therein.

In one embodiment, the intermediate air diffusion layer comprises at least one fabric.

In one embodiment, the at least one fabric of the intermediate air diffusion layer exhibits a plurality of gas channeling features.

According to a second aspect, there is provided a microclimate management system for an occupant support having an occupant receiving surface. The microclimate management system has a top layer disposable above the occupant receiving surface of the occupant support and an intermediate air diffusion layer operatively interposable between the top layer and the occupant receiving surface of the occupant support. The microclimate management system also has a bottom air distribution manifold mountable with the occupant support, the bottom air distribution manifold being configured to regulate at least one of a moisture content and a temperature in at least one microclimate managed area of the occupant support.

In one embodiment, the bottom air distribution manifold includes a plurality of air distribution conduits, each extending at least partially through the occupant support upwardly towards the occupant receiving surface for distributing air to the intermediate air diffusion layer.

In one embodiment, the plurality of air distribution conduits are arranged according to a predetermined pattern, the predetermined pattern corresponding to the at least one microclimate managed area of the occupant support.

In one embodiment, the top layer is moisture permeable.

In one embodiment, the top layer has a moisture vapor transmission rate between about 50 g/m²/24 hrs and 600 g/m²/24 hrs when measured according to ASTM E96-00.

In one embodiment, the microclimate management system is configured to remove moisture that permeates the top layer.

In one embodiment, air distributed to the intermediate air diffusion layer via the bottom air distribution manifold diffuses throughout the intermediate air diffusion layer.

In one embodiment, the top layer is air permeable.

In one embodiment, a substantial portion of the air distributed to the air distribution conduits is evacuated through the top layer.

In one embodiment, the top layer is non-air permeable.

In one embodiment, the top layer is removably connectable to the occupant support via at least one attachment element.

In one embodiment, a substantial portion of the air distributed to the air distribution conduits is evacuated through the at least one attachment element.

In one embodiment, the air distribution conduits are arranged in at least two distant groups.

In one embodiment, the at least two distant groups correspond to at least two microclimate managed areas.

In one embodiment, the at least two microclimate managed areas correspond to distinct anatomical regions of the occupant.

In one embodiment, the microclimate management system further comprises a bottom layer removably connectable to the top layer to form a compartment for enclosing the occupant support and the bottom air distribution manifold therein.

In one embodiment, the microclimate management system further comprises a fire-resistant envelope for enclosing the occupant support therein.

In one embodiment, the microclimate management system further comprises a fluid-resistant envelope for enclosing the occupant support therein, the fluid-resistant envelope having a plurality of air circulation apertures, each being operatively connected to a corresponding one of the plurality of air distribution conduits.

In one embodiment, the bottom air distribution manifold comprises an elongated air supply section disposed below the occupant support, the elongated air supply section being operatively connectable to each of the plurality of air distribution conduits.

In one embodiment, the elongated air supply section comprises a three-dimensional spacer extending therein.

In one embodiment, the intermediate air diffusion layer comprises at least one fabric.

In one embodiment, the at least one fabric of the intermediate air diffusion layer exhibits a plurality of gas channeling features.

According to a third aspect, there is provided a mattress for a microclimate management system. The mattress comprises a base having a length and a width, the base having a top surface, a bottom surface and a cut-out portion extending from the top surface. The cut-out portion has a substantially triangular profile across a longitudinal cross section of the base, the cut-out portion extending across a width of the base and being defined along a length of the base by a first sloped surface directed towards a proximal end of the base and a second sloped surface directed towards a distal end of the base, the first and the second sloped surfaces extending between the top surface and the bottom surface. The mattress also comprises an insert having a substantially triangular profile. The substantially triangular profile of the insert generally corresponds to the substantially triangular profile of the cut-out portion of the base such that, when inserted in the cut-out portion of the base, the base and the insert define a generally planar surface across the top surface of the base. A slope of the second sloped surface is greater than a slope of the first sloped surface. When the insert is inserted into the cut-out portion, the first and the second sloped surfaces of the cut-out portion are configured to distribute at least a portion of a downward force exerted onto the insert towards a region of the base adjacent to the first and the second sloped surfaces of the cut-out portion.

According to a fourth aspect, there is provided a cover for an occupant support. The cover comprises a top portion and a bottom portion, a facing coupled to a peripheral wall of the top portion and disposed on an inner side thereof, a first attachment element coupled to the facing and a second attachment element coupled to a peripheral wall of the bottom portion. The first and second attachment elements are selectively fastened to each other to enclose at least part of the occupant support therebetween. The facing is more rigid than the peripheral wall of the top portion.

According to a fifth aspect, there is provided a method for manufacturing a cover of an occupant support. The method comprises the following steps: coupling an attachment element to a facing; sewing the facing to a peripheral wall of one of a top portion and a bottom portion of the cover to form a first seam near an edge of the peripheral wall, the facing being more rigid than the peripheral wall; folding the facing over the first seam to form a folded end of the facing; folding the peripheral wall of the one of the top portion and the bottom portion of the cover in a same direction as the facing to form a folded end of the peripheral wall generally aligned with the folded end of the facing; and welding the facing to the peripheral wall to form a welding seam that is generally parallel to the first seam.

In one embodiment, after folding the facing over the first seam, the method for manufacturing the cover of the occupant support further comprises sewing the facing to the peripheral wall to form a second seam between two superimposed layers of the facing and the peripheral wall.

### BRIEF DESCRIPTION OF THE DRAWINGS

Reference will now be made to the accompanying drawings, showing by way of illustration example embodiments thereof.

FIG. 1 is a top side perspective view of a microclimate management system mounted with a corresponding occupant support showing an occupant lying thereon, in accordance with one embodiment.

FIG. 2 is an exploded bottom side perspective view of the microclimate management system and the occupant support of FIG. 1.

FIG. 3A is an exploded top side perspective view of a bottom air distribution manifold of the microclimate management system and the occupant support of FIG. 2.

FIG. 3B is an exploded bottom side perspective view of the bottom air distribution manifold of the microclimate management system and the occupant support shown in FIG. 3A.

FIG. 3C is a bottom side perspective view of the bottom air distribution manifold of the microclimate management system and the occupant support shown in FIG. 3A.

FIG. 4 is a partial side cross-section view of air distribution conduits and a portion of the elongated air supply section of the microclimate management system and the occupant support of FIG. 3C, taken along the line A-A.

FIG. 5 is an enlarged view of the dot line circle V of FIG. 4.

FIG. 6 is an exploded bottom side perspective view of another microclimate management system and an associated occupant support, in accordance with another embodiment.

FIG. 7 is an exploded top side perspective view of still another microclimate management system and a corresponding occupant support, in accordance with still another embodiment.

FIG. 8A is a partial enlarged side cross-section view of an air distribution conduit of the microclimate management system mounted with the occupant support of FIG. 7.

FIG. 8B is a top view of another bottom air distribution manifold, in accordance with another embodiment.

FIG. 8C is a top view of still another bottom air distribution manifold, in accordance with still another embodiment.

FIG. 9 is a top side perspective view of a microclimate management overlay and a corresponding occupant support, in accordance with one embodiment.

FIG. 10 is an exploded bottom side perspective view of the microclimate management overlay of FIG. 9.

FIG. 11A is a top side perspective view of a bottom air distribution assembly of the microclimate management overlay of FIG. 10.

FIG. 11B is a partial bottom side perspective view of a portion of the bottom air distribution assembly of the microclimate management overlay of FIG. 11A.

FIG. 11C is a partial top side perspective view of a portion of the bottom air distribution assembly of the microclimate management overlay of FIG. 11A, taken along the line B-B.

FIG. 12 is a top side perspective view of another bottom air distribution assembly, in accordance with another embodiment.

FIG. 13A is a partial exploded top side perspective view of a portion of another bottom air distribution assembly, in accordance with another embodiment.

FIG. 13B is a partial top side perspective view of the portion of the bottom air distribution assembly of FIG. 13A.

FIG. 14A is a bottom side perspective view of an intermediate air diffusion layer of the microclimate management overlay of FIG. 10.

FIG. 14B is a partial bottom side perspective view of the dot line oval XIV of FIG. 14A.

FIG. 14C is a partial exploded top side perspective view of a portion of the intermediate air diffusion layer and a portion of the bottom air distribution assembly of the microclimate management overlay of FIG. 10.

FIG. 14D is a partial top side perspective view of the portion of the microclimate management overlay of FIG. 14C once assembled.

FIG. 15 is a partial top side perspective view of an intermediate air diffusion layer assembled to a bottom air distribution assembly, in accordance with another embodiment.

FIG. 16 is a bottom side perspective view of a top layer mounted with the bottom air distribution assembly of the microclimate management overlay of FIG. 10.

FIG. 17 is a partial cross-sectional side view of a portion of the microclimate management overlay mounted with the occupant support of FIG. 9, taken along the line A-A.

FIG. 18 is a top side perspective view of a foam support, in accordance with one embodiment.

FIG. 19 is an exploded top side perspective view of the foam support of FIG. 18.

FIG. 20 is a cross-sectional top side perspective view of the foam support of FIG. 19, taken along the line C-C.

FIG. 21 is a top view of an air pump module, in accordance with one embodiment, the hanging handles being in a stowed position.

FIG. 22 is another top view of the air pump module of FIG. 21, the hanging handles being in a deployed position.

FIG. 23 is a rear perspective view of the air pump module shown in FIG. 22.

FIG. 24 is a partial enlarged view of the air pump module shown in FIG. 23.

FIG. 25 is another rear perspective view of the air pump module of FIG. 21, the hanging handles being in the stowed position.

FIG. 26 is a rear view of the air pump module of FIG. 21, the hanging handles being in the deployed position.

FIG. 27 is a partially exploded perspective view of the rear side of the air pump module of FIG. 21.

FIG. 28 is a side view of the air pump module shown in FIG. 26.

FIG. 29 is an enlarged view of a portion of the air pump module shown in FIG. 28.

FIG. 30A is a partial cross-sectional view of an intermediate air diffusion layer of the microclimate management system of FIG. 1, in accordance with one embodiment.

FIG. 30B is a partial cross-sectional view of the intermediate air diffusion layer of the microclimate management system of FIG. 1, in accordance with another embodiment.

FIGS. 31A and 31B are a top plan view and a top side perspective view of a fabric of the intermediate air diffusion layer of the microclimate management system of FIG. 1, respectively, in accordance with one embodiment.

FIGS. 32A and 32B are a top plan view and a top side perspective view of a fabric of the intermediate air diffusion layer of the microclimate management system of FIG. 1, respectively, in accordance with another embodiment.

FIGS. 33A and 33B are a top plan view and a top side perspective view of a fabric of the intermediate air diffusion layer of the microclimate management system of FIG. 1, respectively, in accordance with still another embodiment.

FIGS. 34A and 34B are a top plan view and a top side perspective view of a fabric of the intermediate air diffusion layer of the microclimate management system of FIG. 1, respectively, in accordance with still another embodiment.

FIG. 35 is a partial top side perspective view of a top layer secured to a bottom layer of the microclimate management system of FIG. 6 via an attachment element and showing a flap in flipped up position, in accordance with an embodiment.

FIG. 36 is a partial top side perspective view of the top layer secured to the bottom layer of FIG. 35 and showing the flap in flipped down position.

FIG. 37 is a partial cross-sectional view of the top layer and the flap of FIG. 36.

FIG. 38 is a top side perspective view of a top layer secured to a flap and showing two seams between the top layer and the flap, in accordance with an embodiment.

FIG. 39 is a partial cross-sectional view of the top layer secured to the flap of FIG. 38 and showing a welded line between the top layer and the flap.

FIG. 40 is a partial side elevation view of the bottom layer of FIG. 39 showing an attachment element, in accordance with an embodiment.

FIGS. 41A and 41B are top side perspective views of the bottom layer of FIG. 40 showing an attachment element in an un-fastened and in a fastened position, respectively.

FIG. 42 is a top side perspective view of a support layer, in accordance with one embodiment.

FIG. 43 is a cross-sectional view of the support layer of FIG. 42 taken along line 43-43 in FIG. 42.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

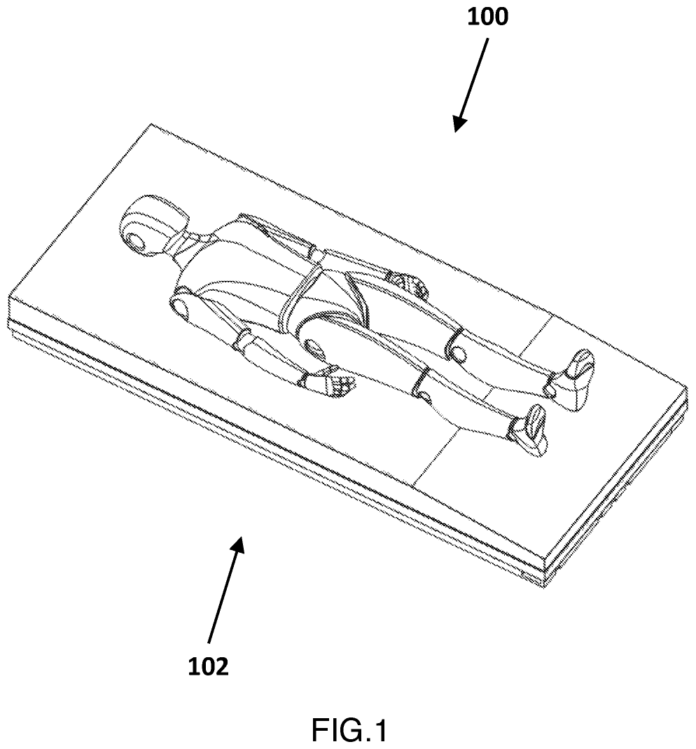

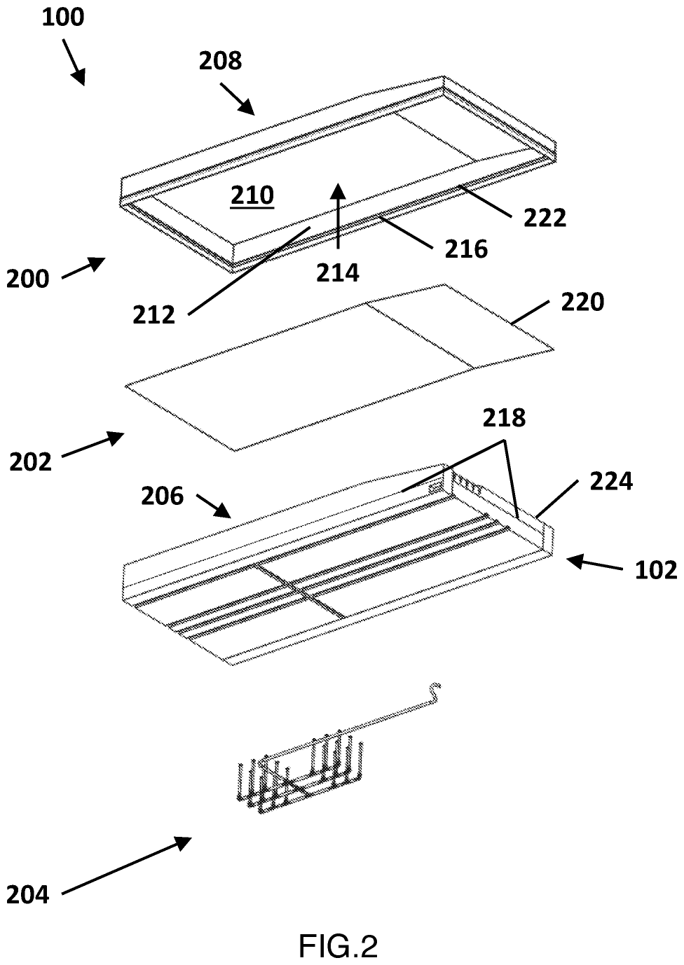

Referring to FIGS. 1 and 2, a microclimate management system 100 mountable with a corresponding occupant support 102 will be described, according to one embodiment of the first aspect of the present disclosure. The occupant support 102 may also be referred to as a “patient support surface”.

In the illustrated embodiment, the microclimate management system 100 is provided with a top layer 200, an intermediate air diffusion layer 202, and a bottom air distribution manifold 204. The top layer 200 is disposable over an occupant receiving surface 206 of the occupant support 102, while the intermediate air diffusion layer 202 is operatively interposable between the top layer 200 and the occupant support 102 and covers at least partially the occupant receiving surface 206. The bottom air distribution manifold 204, when mounted with the occupant support 102, is devised to circulate air towards the occupant receiving surface 206 in order to distribute air to the intermediate air diffusion layer 202 mounted thereon where air diffuses therethrough, as it will become apparent hereinafter.

The top layer 200 has a top face 208, an opposed bottom face 210, and a peripheral wall 212 extending downwardly from the bottom face 210 along the periphery thereof. The top layer 200 may also be referred to as a “top cover” of the microclimate management system 100 as it defines at least in part a top exterior surface thereof. When disposed above the occupant support 102, the top and bottom faces 208 and 210 of the top layer 200 are substantially aligned with the occupant receiving surface 206 of the occupant support 102, while the peripheral wall 212 generally extends along the periphery of the occupant support 102. As such, the peripheral wall 212 and the bottom face 210 of the top layer 200 together define an upper cavity 214 that is configured to receive the intermediate air diffusion layer 202 therein and an upper portion of the occupant support 102, including at least the occupant receiving surface 206.

In one embodiment, the material of the top layer 200 is a four-way or a two-way stretchable material to minimize shear forces in the contact areas between the occupant and the top layer 200, notably to improve comfort to the occupant when the occupant rests on the occupant support 102.

In one embodiment, the top layer 200 is made of a material that reduces the coefficient of friction between the top layer 200 and the skin and/or the garment of the occupant resting on the occupant support 102.

In one embodiment, and as further discussed below, the material of the top layer 200 is configured to regulate the microclimate around the skin of the occupant, specifically the microclimate around at least one region of the occupant's skin which is in contact, either directly or through a garment, with the occupant support 102. Within the context of the present disclosure, the term microclimate is understood to refer at least to the temperature, humidity/moisture and wetness of the microenvironment of a given region between the occupant resting on the occupant support 102 and the occupant support 102.

The top layer 200 may be permeable to moisture and impermeable to air or permeable to both air and moisture. When the top layer 200 is impermeable to air, it will be appreciated that air may still be released from the microclimate management system 100 through other regions of the microclimate management system 100, for example via the attachment element 216, as further discussed below.

In one embodiment, the top layer 200 is moisture permeable and is generally configured to enable the transfer of moisture across the top layer 200, that is across the material of the top layer 200. For example, the top layer 200 has a moisture vapor transmission rate (MVTR) that enables humidity and moisture from the occupant lying on the occupant support 102 to permeate therethrough, into the intermediate air diffusion layer 202 disposed below, to regulate the microclimate environment around and/or between the occupant and the occupant support 102. Exemplary MVTR varying between about 50 to 600 g/m²/24 hrs (when measured according to ASTM E96-00 upright) may be selected. As will be further discussed hereinafter with reference to FIG. 2, the circulation of air from the elongated air supply section 300 towards the intermediate air diffusion layer 202 guides and releases the humidity/moisture that permeated through the top layer 200 from the microclimate management system 100.

In one embodiment, the top layer 200 may include a plurality of regions across the surface of the top layer 200 (i.e., in a horizontal/planar direction), each one of the plurality of regions generally corresponding to a distinct anatomical region of the occupant resting on the occupant support 102. For example, the top layer 200 may include a head region, a back region, a seat region and the likes. In this embodiment, each one of the plurality of regions may be made of distinct materials exhibiting different mechanical properties and/or permeability characteristics and/or attributes (e.g., abrasion resistance, adhesive properties, antimicrobial properties, flame resistance, durability, elasticity, thermal resistance, ultraviolet resistance and the likes), for example to accommodate distinct microclimate environments or comfort requirements in different anatomical regions of the occupant resting on the occupant support 102.

Exemplary materials for the top layer 200 include, but are not limited to, polyurethane transfer coating on warp knitted polyester fabric or polyurethane transfer coating on weft knitted polyamide fabric.

In one embodiment, the top layer 200 is attachable to the occupant support 102. For example, the top layer 200 may be provided with a first attachment element 216 extending at least partially along the peripheral wall 212, for example inside the upper cavity 214. The first attachment element 216 may cooperate with a corresponding attachment element 218 provided on the occupant support 102 and extending at least partially along the periphery thereof such that the top layer 200 may be removably secured to the occupant support 102. The attachment elements 216 and 218 may be airtight or non-airtight (i.e., they may be configured to generally enable, or not, the flow of gas, including air, and may include a zipper, a set of buttons, Velcro™ or attachment straps as non-limitative examples. In an alternative embodiment, the attachment element 216 may also be provided with an elastic band devised to be mounted around the occupant support 102. In such a case, the occupant support 102 has not to be provided with the attachment element 218.

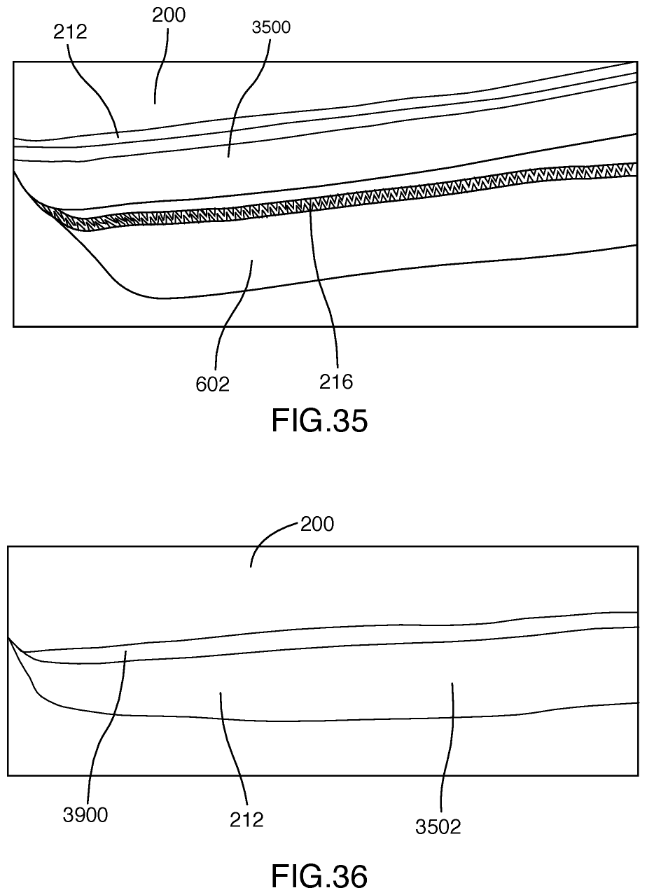

In one embodiment, the first attachment element 216 may be secured onto a facing 3500 extending along the peripheral wall 212 of the top layer 200, as it will become apparent hereinafter with reference to FIGS. 35 to 37.

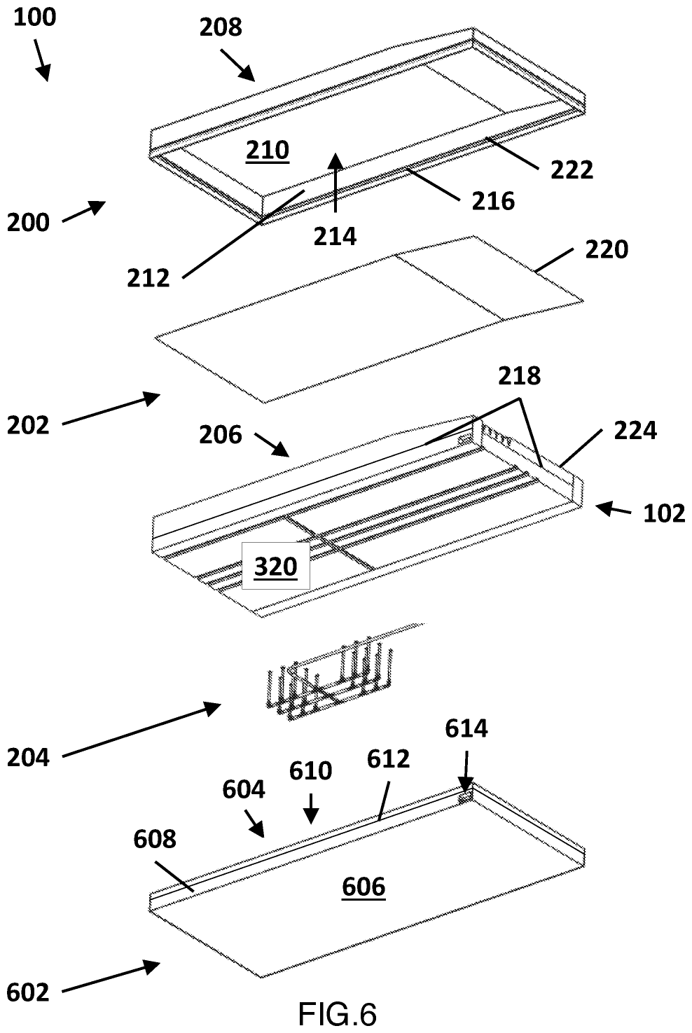

In one embodiment, the top layer 200 may be attachable to a bottom layer 602 mountable below the occupant support 102, as it will become apparent hereinafter with reference to FIG. 6.

With reference to FIG. 2, the intermediate air diffusion layer 202 will now be described. The intermediate air diffusion layer 202 is interposed between the top layer 200 and the occupant support 102 for diffusing air supplied to the occupant support 102 by the bottom air distribution manifold 204. In one embodiment, the intermediate air diffusion layer 202 is made of at least one fabric (i.e., at least one fiber-based material).

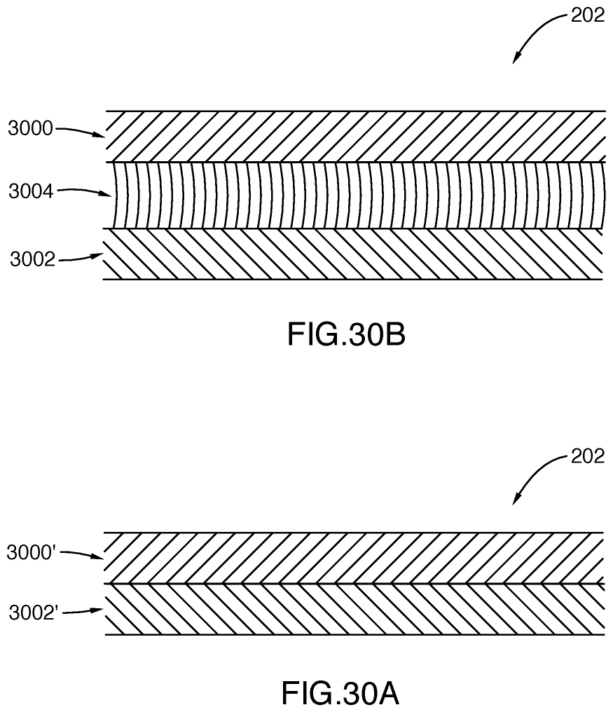

In one embodiment, the intermediate air diffusion layer 202 of the microclimate management system 100 may be made of a compressible and/or crushable and/or resilient material having a selected thickness, such as a three-dimensional spacer that enables air to be distributed therein and to diffuse therethrough, while providing comfort to the occupant of the occupant support 102. Within the context of the present disclosure, the term three-dimensional spacer is understood to refer to a fabric generally having the structure illustrated in FIG. 30B, and in which two surface layers 3000, 3002, namely an outer layer 3000 and an inner layer 3002, are separated by a spacer layer 3004. The three-dimensional spacer fabric may be a weft-knitted spacer fabric or a warp-knitted spacer fabric. In a non-limiting example, the thickness of the intermediate air diffusion layer 202 may be from about 4 mm to about 10 mm.

In this embodiment, and with further reference to FIG. 30B, the outer layer 3000 and the inner layer 3002 are connected via the spacer layer 3004 positioned between the outer layer 3000 and the inner layer 3002. In non-limiting examples, the outer layer 3000, the inner layer 3002 and the spacer layer 3004 could be made of a blend of polyester fiber, polypropylene fiber and spandex fiber or a single one thereof. The spacer layer 3004 is generally configured to define a space between the outer layer 3000 and the inner layer 3002 that enables the transfer of a gas (such as air) therethrough. For example, the spacer layer 3004 may have a density that is less than a density of the outer layer 3000 and the inner layer 3002. In another non-limiting example, the spacer layer 3004 is made of a monofilament fabric that imparts a resistance to the spacer layer 3004 against compressive forces exerted onto the outer layer 3000 and/or the inner layer 3002. In other words, in this non-limiting example, the thickness of the spacer layer 3004 remains substantially constant whether compressive forces are exerted onto the outer layer 3000 and/or the inner layer 3002 or not.

In other embodiments, the intermediate air diffusion layer 202 may be made of a fabric that is not a three-dimensional spacer (i.e., a fabric without a spacer layer), including but not limited to a two-dimensional fabric. Such a fabric of the intermediate air diffusion layer 202 may be made of a natural fiber or a synthetic fiber. Examples of natural fibers include, but are not limited to, cotton, linen, hemp, wool, silk, ramie, sisal, coir and the likes. Examples of synthetic fibers include, but are not limited to, cellulose, nylon, polyester (including aromatic polyester fibers such as VECTRAN® fibers), polypropylene, polyethylene (including polyethylene terephthalate fibers, high-density polyethylene fibers, low-density polyethylene fibers, linear low-density polyethylene fibers, ultra-high molecular weight polyethylene fibers such as DYNEEMA® and SPECTRA® fibers, high-performance polyethylene fibers such as TSUNOOGA™ fibers), polyvinyl chloride, polycarbonate, polyoxazole (including poly(p-phenylene-2,6-benzobisoxazole) fibers such as ZYLON® fibers), polyether ether ketone, polyetherimide (such as ULTEM® fibers), polyarylate (such as ZXION® fibers), polyphenylene sulfide, spandex, viscose, rayon, acetate, triacetate, acrylic, modacrylic, olefin, aramid (such as KEVLAR®, TECHNORA® and TWARON® fibers), metal (such as aluminum, silver, copper and zinc) and the likes.

It will be appreciated that the type of fiber (or fibers, as further discussed below) used in the material may be selected to confer a number of attributes to the intermediate air diffusion layer 202, for example in terms of antimicrobial resistance, abrasion resistance, resistance to static electricity, washability and the likes.

In one embodiment, the fabric of the intermediate air diffusion layer 202 may be a monofilament fabric or a multifilament fabric. Within the context of the present disclosure, the term monofilament fabric is understood to refer to a single-thread fabric and the term multifilament fabric is understood to refer to a multi-thread fabric.

The fabric of the intermediate air diffusion layer 202 may be a knitted fabric or a woven fabric, including weft-knitted fabric and warp-knitted fabric. Within the context of the present disclosure, the term knitted fabric is understood to refer to a fabric made up of a single yarn and the term woven fabric is understood to refer to a fabric made up of at least two yarns crossing each other at a substantially right angle. Weft-knitted fabrics are produced by feeding the yarn in a direction parallel (i.e., horizontal) to the direction of production. Warp-knitted fabrics are produced by feeding the yarn in a direction perpendicular (i.e., vertical) to the direction of production. Examples of knitted fabrics include, but are not limited to, jersey knit, single knit, purl knit, rib knit, French terry knit, double knit, cable knit, interlock knit, jacquard knit, ponte knit, raschel knit, tricot knit, valour knit and the likes. Examples of woven fabrics include, but are not limited to, plain weave fabric, satin weave fabric and twill weave fabric.

The fabric of the intermediate air diffusion layer 202 may be made of a single fiber or may be a blend, i.e. it may be made of at least two different fibers. The at least two different fibers may or may not be of the same fiber type (i.e., the at least two different fibers may include natural fibers and synthetic fibers). The intermediate air diffusion layer 202 may also be made of more than one fabric, which may or may not be a blend, as further discussed below.

The fabric of the intermediate air diffusion layer 202 may be coated, for example by direct coating or transfer coating. Exemplary coatings include, but are not limited to, polymer coatings (such as polyurethane coatings and resin coatings) and microparticles coatings. Coating the fabric of the intermediate air diffusion layer 202 may be also used to confer a number of attributes to the intermediate air diffusion layer 202, such as, but not limited to, abrasion resistance, adhesive properties, antimicrobial properties, flame resistance, durability, elasticity, thermal resistance, ultraviolet resistance and the likes.

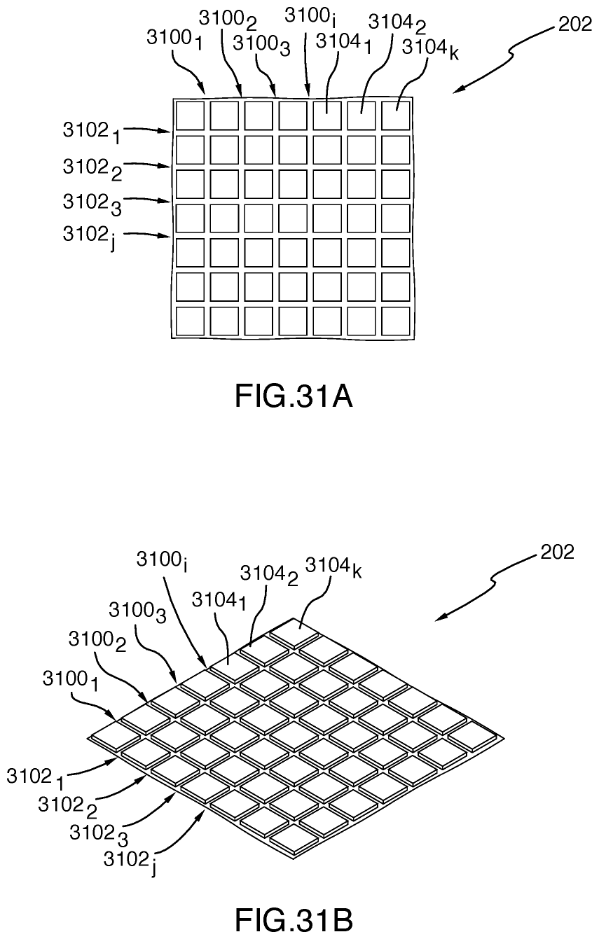

In one embodiment, and with further reference to FIGS. 31A to 34B, the fabric of the intermediate air diffusion layer 202 may exhibit a dimensional profile across a thickness of the intermediate air diffusion layer 202. Within the context of the present disclosure, the term dimensional profile is understood to refer to a non-planar profile across a thickness of the intermediate air diffusion layer 202. This non-planar profile defines a plurality of convex and concave patterns across a surface of the intermediate air diffusion layer 202, also referred to as gas channeling features. The gas channeling features enable the movement and/or transfer of a gas (such as air) across the surface of the intermediate air diffusion layer 202, including when a compressive force is exerted onto the intermediate air diffusion layer 202, for example when an occupant rests on the occupant support 102. As further discussed below, the gas channeling features of the fabric of the intermediate air diffusion layer 202 may be configured in a number of non-limiting ways.

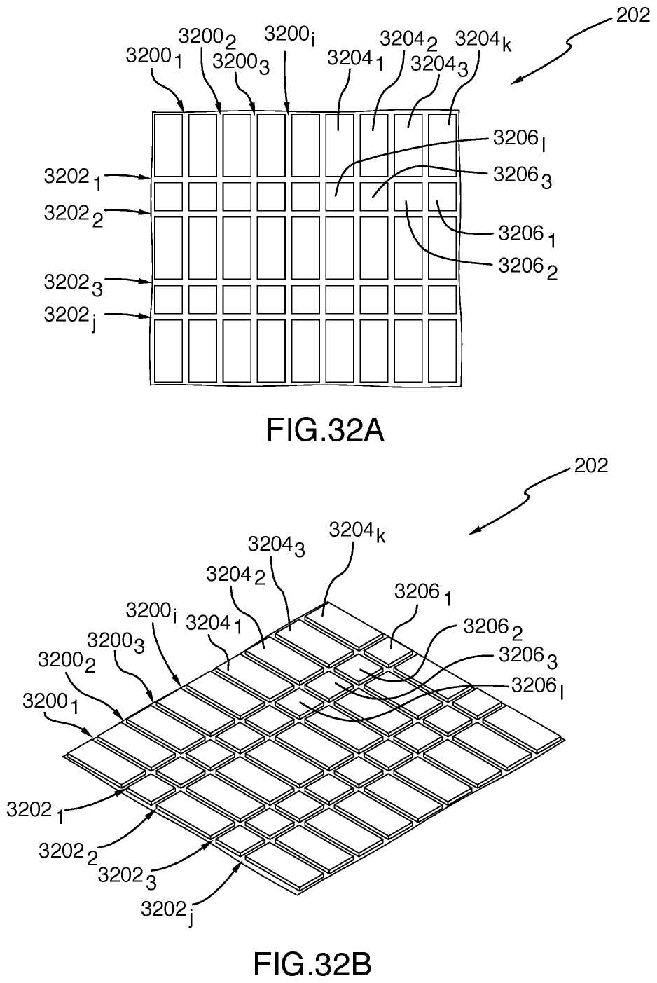

With reference to FIGS. 31A to 32B, non-limiting examples of fabrics with gas channeling features are shown. In the intermediate air diffusion layer 202 of FIGS. 31A and 31B, the fabric comprises a plurality of generally equidistant linear grooves 31001 along a first direction of the intermediate air diffusion layer 202, as well as a plurality of generally equidistant linear grooves 3102ⱼ along a second direction of the intermediate air diffusion layer 202, the second direction being generally perpendicular to the first direction. The linear grooves 3100ᵢ and 3102ⱼ generally exhibit the same thickness and are interspaced by the same distance, resulting in the formation of a regular checkered pattern of generally squared protrusions 3104ₖ across the top face 208 of the intermediate air diffusion layer 202.

In the intermediate air diffusion layer 202 of FIGS. 32A and 32B, the fabric comprises a plurality of generally equidistant linear grooves 32001 along a first direction of the intermediate air diffusion layer 202, as well as a plurality of linear grooves 3202ⱼ interspaced by two distinct and alternating distances along a second direction of the intermediate air diffusion layer 202, the second direction being generally perpendicular to the first direction. The linear grooves 32001 and 3202ⱼ generally exhibit the same thickness but are not interspaced by the same distance, resulting in the formation of an irregular checkered pattern of generally rectangular protrusions 3204ₖ and generally squared protrusions 3206ₗ across the top face 208 of the intermediate air diffusion layer 202.

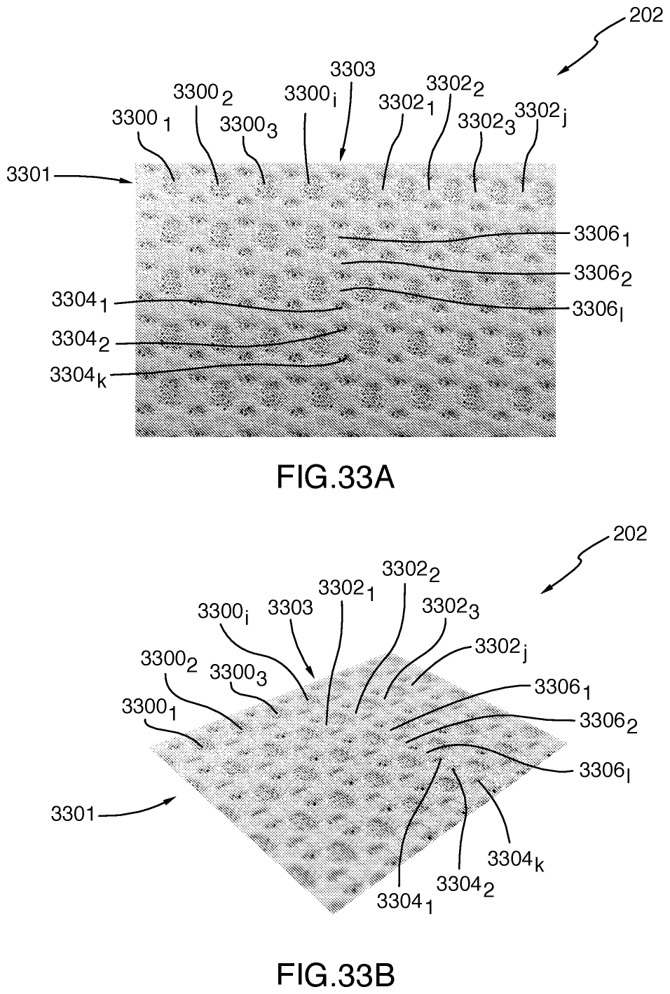

In the intermediate air diffusion layer 202 of FIGS. 33A and 33B, the fabric comprises a plurality of generally equidistant and alternating convex and concave regions in two generally perpendicular directions. For example, the fabric comprises a plurality of convex regions 3302ⱼ and a plurality of concave regions 3300ᵢ along a first direction (shown by row 3301 in FIG. 33A), as well as a plurality of convex regions 3306ₗ and a plurality of concave regions 3304ₖ along a second direction (shown by column 3303 in FIG. 33A) generally perpendicular to the first direction. In the non-limiting example of FIGS. 33A and 33B, the plurality of convex and concave regions 3306ₗ, 3304ₖ exhibit different alternating shapes across both the first and the second directions.

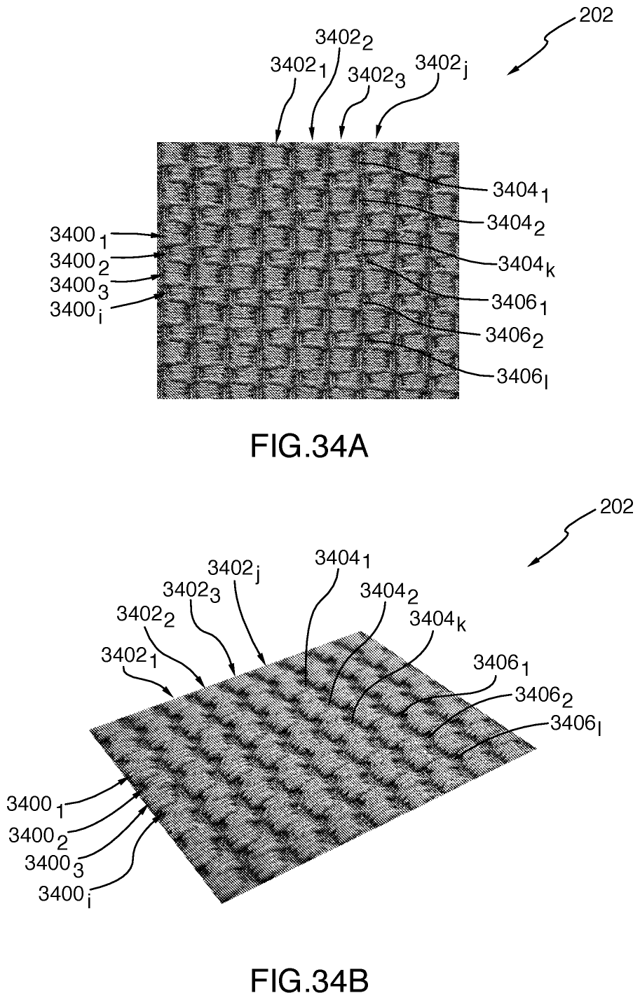

In the intermediate air diffusion layer 202 of FIGS. 34A and 34B, the fabric comprises a plurality of columns 3402ⱼ of substantially aligned individual protrusions 3400ᵢ having a generally rectangular shape. The protrusions of 3400ᵢ of each column 3402ⱼ are alternatingly staggered such that, in each column 3402ⱼ, each two consecutive protrusions 3400ᵢ are partly offset from each other. The protrusions 3400ᵢ define a plurality of grooves 3404ₖ and 3406ₗ between the plurality of columns 3402ⱼ. In the non-limiting example of FIGS. 34A and 34B, the plurality of grooves 3404ₖ and 3406ₗ are not aligned and extend generally parallel to each other.

It will be appreciated that the dimensional profile of the intermediate air diffusion layer 202 may be achieved using a variety of other configurations without departing from the scope of the present disclosure.

Exemplary materials for the intermediate air diffusion layer 202 include the Evertek™ line of fabrics from Everest Textile Co., Ltd. as well as textiles with a dimensional profile from Laprotex textiles, as non-limitative examples.

In another embodiment, with further reference to FIG. 30A, the intermediate air diffusion layer 202 may comprise more than one fabric. For instance, the intermediate air diffusion layer 202 may comprise two fabrics layered one above the other such that they form an outer layer 3000′ and an inner layer 3002′ positioned below the outer layer 3000′. The outer layer 3000′ and the inner layer 3002′ may be made of distinct fabrics exhibiting different mechanical properties and/or permeability characteristics. In a non-limiting example, the outer layer 3000′ of the intermediate air diffusion layer 202 is made of a blend of polyester, polypropylene and spandex fibers, and the inner layer 3002′ of the intermediate air diffusion layer 202 is made of polyester fiber.

It will also be appreciated that the outer layer 3000′ and/or the inner layer 3002′, as shown in the embodiments of FIG. 30A, may be made of a fabric with a dimensional profile as described therein, with natural and/or synthetic fibers as described therein. For instance, the outer layer 3000′ could comprise any one of the fabrics shown in FIGS. 31A to 34B and the inner layer 3002′ could comprise any other one, or a same one, of the fabrics shown in FIGS. 31A to 34B. Notably, by layering two or more such fabrics, it is contemplated that the benefits of each fabric with regard to gas distribution and/or compressive performance may be to a certain extent combined to obtain a synergistic combination.

In one embodiment, the intermediate air diffusion layer 202 may be attached to the top layer 200. For example, the intermediate air diffusion layer 202 may be provided with an attachment element 220 extending at least partially along its periphery. The attachment element 220 may cooperate with a corresponding second attachment element 222 provided on the top layer 200 and extending at least partially along its periphery. Exemplary attachment elements 220 and 222 may include a zipper, buttons, Velcro™ or attachment straps for example in order to provide a removable attachment. Alternatively, the intermediate air diffusion layer 202 may be permanently attached to the top layer 200, for example by radiofrequency (RF) or ultrasound welding, sewing or other appropriate techniques. Such permanent attachment may be implemented along the periphery of the intermediate air diffusion layer 202, and/or on various attachment points provided thereon, for example at the corners thereof.

In another embodiment, the intermediate air diffusion layer 202 may be attachable to the occupant support 102. For example, the attachment element 220 of the intermediate air diffusion layer 202 may cooperate with a corresponding attachment element 224 provided on the occupant support 102 and extending at least partially along its periphery. The intermediate air diffusion layer 202 may be removably attached to the occupant support 102. Exemplary attachment elements 220, 224 may include a zipper, buttons, Velcro™ or attachment straps. Alternatively, the intermediate air diffusion layer 202 may be permanently attached to the occupant support 102, for example by radiofrequency (RF) or ultrasound welding, sewing or other appropriate techniques. Such permanent attachment may be implemented along the periphery of the intermediate air diffusion layer 202, and/or on various attachment points on the occupant receiving surface 102, for example at the corners thereof.

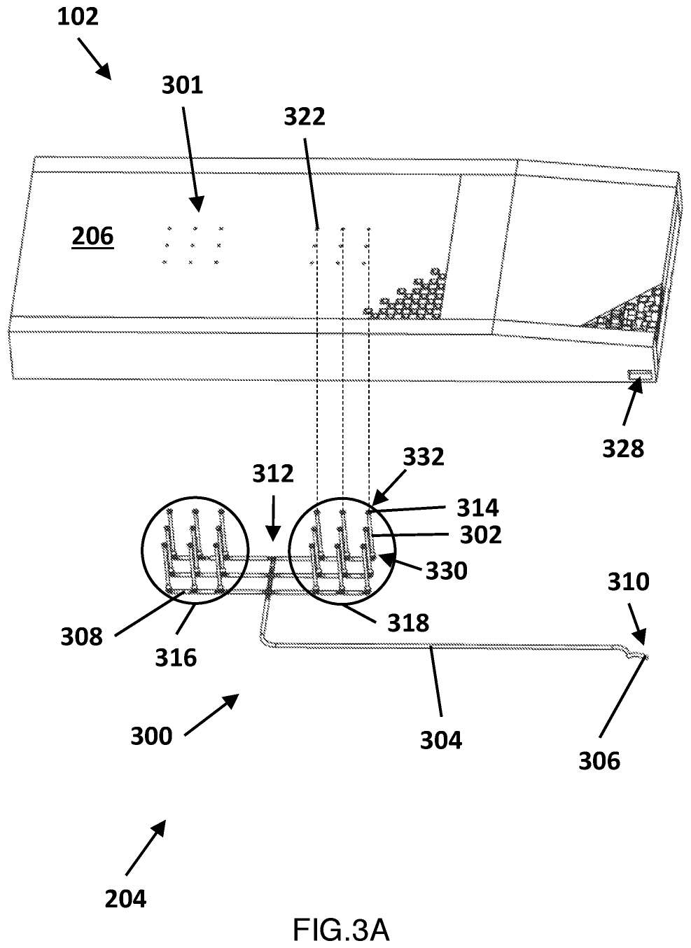

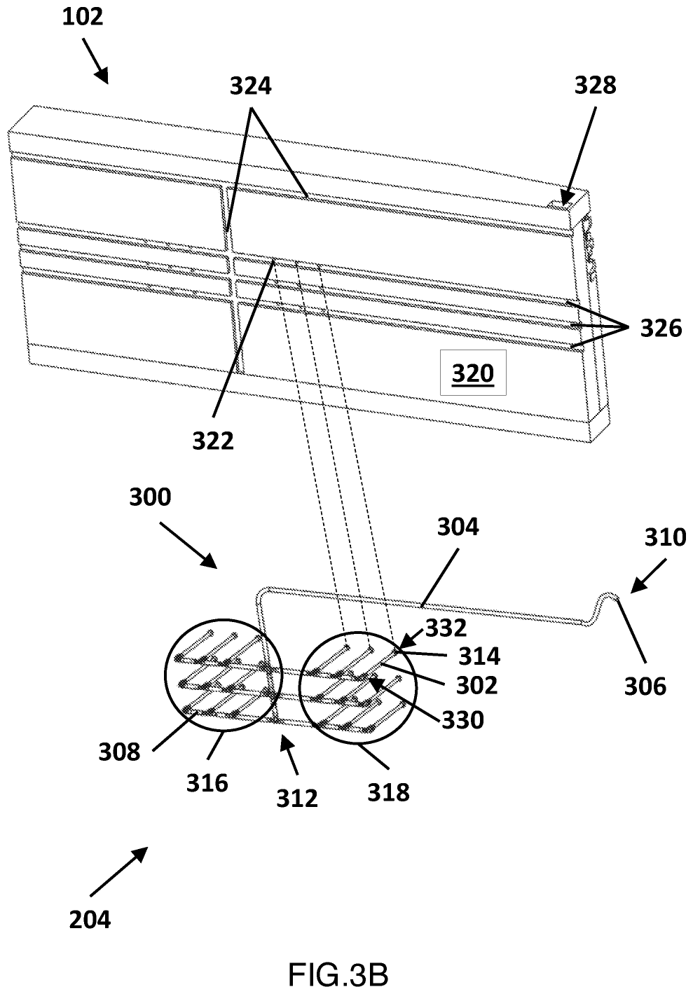

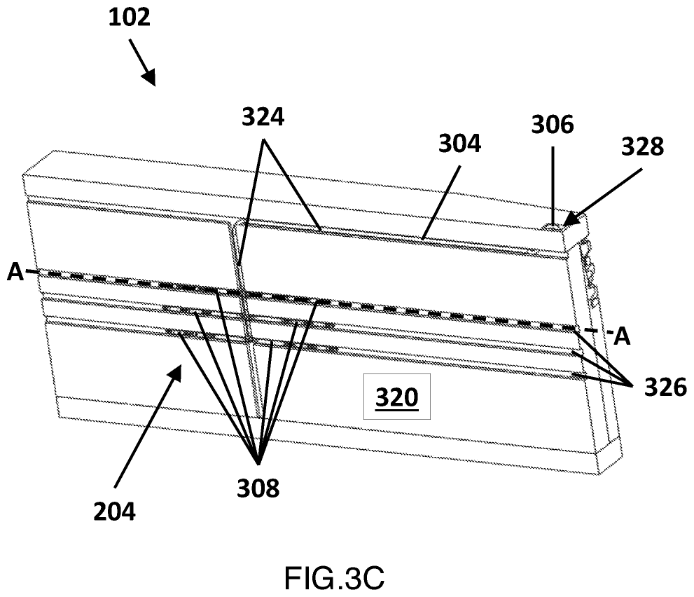

FIGS. 3A to 3C illustrate an embodiment of a bottom air distribution manifold 204 which is mountable with the occupant support 102, according to one embodiment, for providing air to the intermediate air diffusion layer 202. In this embodiment, the bottom air distribution manifold 204 is provided with an elongated air supply section 300 devised to be mounted horizontally below the occupant receiving surface 206. The elongated air supply section 300 is provided with a main supply hose 304 and a connector 306 extending at a distal end 310 thereof. The connector 306 is operatively connectable to an air supply module (not shown) for providing air to the bottom air distribution manifold 204. The elongated air supply section 300 also has a plurality of supply hose extensions 308 extending at the end portion 312 opposed to the distal end 310 thereof and operatively connected to the main supply hose 304. In the illustrated embodiment, the supply hose extensions 308 are coplanar to each other and to the main supply hose 304. As illustrated, there are 3 supply hose extensions 308 parallel to each other on each side of the end portion 312 of the main supply hose 304.

It will be appreciated that, in some embodiments, the air supply module may be used to control at least one parameter of the air being provided to the intermediate air diffusion layer 202, including but not limited to the air temperature. In one non-limiting example, the temperature of the air provided to the intermediate air diffusion layer 202 may be adjusted to improve the comfort of the occupant resting on the occupant support 102, for example by increasing or decreasing the air temperature depending on the state of the occupant resting on the occupant support 102.

The bottom air distribution manifold 204 further has a plurality of air distribution conduits 302, each being operatively connected to the main supply hose 304 through a corresponding supply hose extension 308, and each extending substantially perpendicularly therefrom. In the illustrated embodiment, 18 air distribution conduits 302 are provided, 3 on each side of the 3 supply hose extensions 308. As shown in FIG. 3A, this described arrangement of the air distribution conduits 302 defines a predetermined pattern relative to the occupant receiving surface 206 for defining a microclimate managed area 301, as it should become apparent below. Within the context of the present disclosure, the term microclimate managed area is understood to refer to an area of the occupant support 102 where the microclimate around the occupant's skin, which is in contact with the occupant support 102 either directly or through a garment, is regulated via the distribution of air through the plurality of air distribution conduits 302. For example, the microclimate managed area may be regulated because the air distributed via the plurality of air distribution conduits 302 eliminates the humidity/moisture that permeates across the top layer 200 or otherwise regulates the temperature of the microclimate managed area, which is directly affected by the occupant's temperature. In the illustrated embodiment of FIGS. 3A and 3B, the air distribution conduits 302 are arranged in a first and a second distant groups 316, 318, each devised to distribute air to specific distinct areas.

The skilled addressee will appreciate that various configurations for the supply hose 304, the connector 306, the supply hose extensions 308 and the air distribution conduits 302 may be contemplated without departing from the scope of the present disclosure.

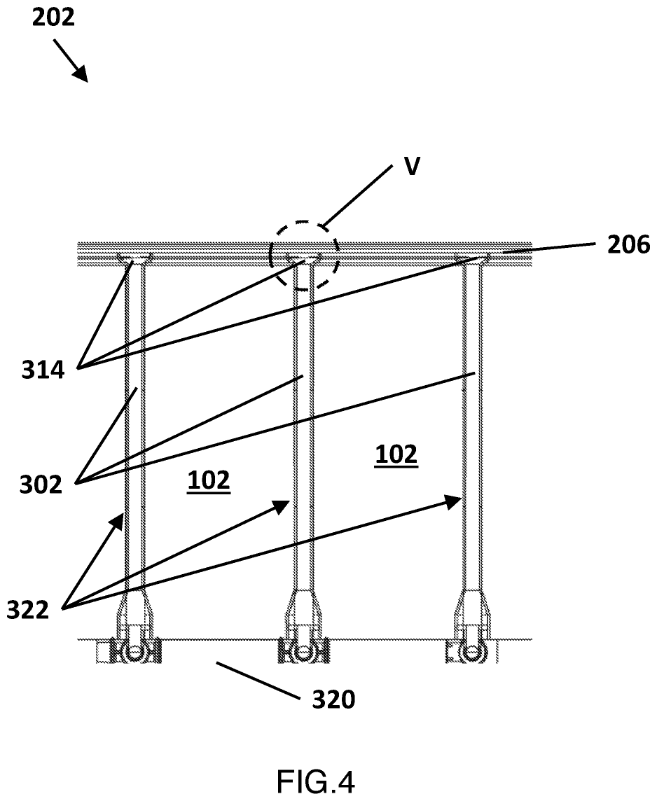

When mounted with the occupant support 102, as in the embodiment illustrated in FIGS. 3A to 3C and also in FIG. 4, the air distribution conduits 302 extend through the occupant support 102 substantially upwardly, towards the occupant receiving surface 206 to distribute air to the intermediate air diffusion layer 202. Each of the air distribution conduits 302 is provided with a corresponding distribution port 314 at an upper end thereof which cooperates with the intermediate air diffusion layer 202 to distribute air thereto, as detailed below. The air distribution conduits 302 are each received in a corresponding one of a plurality of air passageways 322 provided through the occupant support 102 while the elongated air supply section 300 is received at the bottom portion 320 of the occupant support 102.

As illustrated in FIGS. 3B and 3C, the elongated air supply section 300 is received in a corresponding L-shaped groove 324 and a corresponding plurality of longitudinal grooves 326, both provided on the bottom face 320 of the occupant support 102. The L-shaped groove 324 has a first portion which extends longitudinally along a longitudinal side of the bottom face 320 of the occupant support 102 and a second portion which extends transversally. The longitudinal grooves 326 extend longitudinally on the bottom face 320 of the occupant support 102. The connector 306 is arranged to be receivable in a connector opening 328 provided on the peripheral wall of the occupant support 102, and further in a connector opening (not shown) provided on the peripheral wall 212 of the top layer 200.

When received in the corresponding air passageways 322, the air distribution conduits 302 of the air distribution manifold 204 extend between the bottom face 320 and the receiving surface 206 of the occupant support 102 such that the ports distribution 314 of the air distribution manifold 204 are positioned to or proximal to the occupant receiving surface 206 and are in fluid communication with the intermediate air diffusion layer 202 to distribute air thereto. As such, the first and second groups 316 and 318 of air distribution conduits 302 each define a corresponding distinct microclimate managed area 301 on the receiving surface 206. For example, the first group 316 may be used for the occupant's back region while the second group 318 may be used for the occupant's seat region, for preventing and/or minimizing skin wounds, pressure ulcers, and/or bedsores generally associated with extended bed rest.

It will be appreciated that any number and any configuration of the air distribution conduits 302 and corresponding distribution ports 314 may be contemplated without departing from the scope of the present disclosure. The various therapeutic zones may also be differently designed and/or be operated simultaneously or independently, according to a specific application.

In some non-limiting examples, the air distribution conduits 302 of the bottom air distribution manifold 204 may be configured to define a plurality of microclimate managed areas and each one of the plurality of the microclimate managed areas may be regulated independently from the others. For example, a microclimate managed area corresponding to any one of a back region, a seat region, a head region or a feet region of the occupant support 102 may be regulated independently from the other regions.

The receiving of the elongated air supply section 300 on the bottom face 320, spaced apart from the occupant receiving surface 206 of the occupant support 102, enables to minimize impact on the comfort perceived by an occupant of the occupant support 102 while preventing or mitigating the collapsing of the elongated air supply section 300 under the occupant's weight. Since the air distribution conduits 302 of the air distribution manifold 204 extend substantially upwardly between the bottom face 320 and the occupant receiving surface 206 of the occupant support 102, they are less prone to undesired collapsing due to the occupant's weight.

In one embodiment, one of several portions of the bottom air distribution manifold 204 may be provided with a three-dimensional spacer therein, with at least one fabric exhibiting a dimensional profile, or with any other resilient or crushable material such as a foam or a thick fibered fabric for preventing or at least further reducing any undesired collapsing that may occur and block the passage of air therethrough. In one embodiment, only the elongated air supply section 300 extending horizontally is provided with a three-dimensional spacer extending therein or with at least one fabric exhibiting a dimensional profile. In a further embodiment, the air distributions conduits 302 are also provided with a corresponding three-dimensional spacer extending therein or with at least one fabric exhibiting a dimensional profile.

The bottom air distribution manifold 204 of the microclimate management system 100 is preferably made of a flexible material, and in one embodiment may be made of a material specifically devised for maintaining anon-collapsed structure even under load. Exemplary material for the air distribution conduits 302 includes DAF supple knit weldable.

In another embodiment, the bottom air distribution manifold 204 may be mounted inside the structure of the occupant support 102, between the bottom face 320 and the occupant receiving surface 206.

In operation, the connector 306 is operatively connected to a blower or an air pump and conveys air (not shown) to the supply hose 304, the supply hose extensions 308, and the air distribution conduits 302 towards the intermediate air diffusion layer 202.

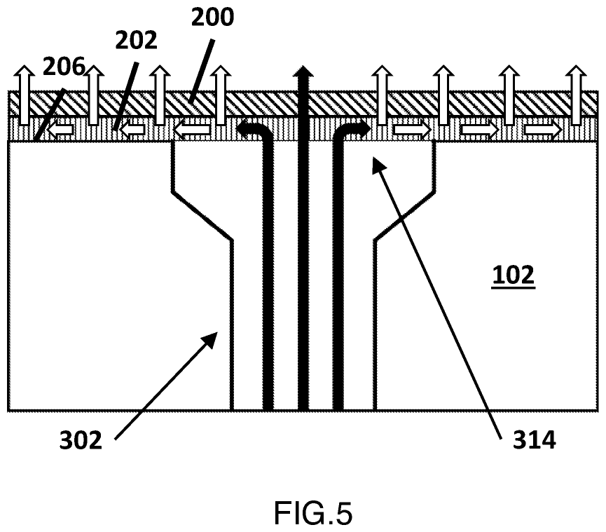

More particularly, as illustrated in FIG. 5, air from the air distribution conduits 302 flows through the corresponding distribution ports 314 to the intermediate air diffusion layer 202. Air then diffuses inside the intermediate air diffusion layer 202 and creates air flows devised to help evaporating occupant' humidity which has been previously accumulated therein.

In one embodiment, the top layer 200 is selected such that air that is supplied from the air distribution conduits 302 does not permeate substantially therethrough in operation (i.e., the top layer is substantially air impermeable). Instead, in this embodiment, a substantial portion of air that is supplied from the air distribution conduits 302 is evacuated through the attachment elements 216, 218, which define a non-airtight attachment. The air flows that are thus created inside the intermediate air diffusion layer 202 help to evaporate and evacuate humidity and moisture that may have previously accumulated therein.

In another embodiment, top layer 200 is selected such that air that is supplied from the air distribution conduits 302 substantially permeate therethrough in operation. In other words, in this embodiment, a substantial portion of air that is supplied from the air distribution conduits 302 is evacuated through the top layer 200 and the attachment elements 216, 218 may or may not define a non-airtight attachment.

It will be appreciated that the bottom air distribution manifold 204 may be mountable with various types of occupant support 102, such as mattresses made of foam or inflatable fluid bladders or any combination thereof, as further discussed below. In the case of mattresses made of adjacent inflatable fluid bladders, for example, the air distribution conduits 302 and corresponding distribution ports 314 of the bottom air distribution manifold 204 may be positioned and extend between adjacent inflatable fluid bladders or through any structure attaching the fluid bladders together.

In one embodiment, the occupant support 102 has an occupant receiving surface 206 that comprises a resilient support layer configured to support the occupant. The resilient support layer is designed to be resilient such that, when the occupant lies on the occupant support 102, the resilient support layer of the occupant receiving surface 206 deforms considerably under the weight of the occupant and generally conforms to the shape of the occupant's body, effectively enveloping part of the occupant's body. This immersion of the occupant's body into the resilient support layer of the occupant receiving surface 206 allows a distribution of the occupant's weight over a greater surface area, thereby minimizing the risk of developing pressure ulcers (e.g., for an occupant with limited mobility or an occupant confined to a bed for a long duration for any given reason).

In this embodiment, the resilient support layer of the occupant receiving surface 206 is made of one or more resilient materials. More specifically, in this example, the resilient support layer of the occupant receiving surface 206 is formed from multiple distinct pieces having different rigidities. For example, the resilient support layer of the occupant receiving surface 206 has a central portion that has a different rigidity from right and left lateral portions located on the lateral sides of the central portion. In particular, the resilient material of the lateral portions has a greater rigidity than the resilient material of the central portion. In this example, each of the central portion and the lateral portions extends along an entirety of the length of the occupant receiving surface 206. It is contemplated that additional portions of the resilient support layer of the occupant receiving surface 206 could have different rigidities (e.g., a foot portion, a leg portion, a head portion, etc.).

In this embodiment, the resilient support layer of the occupant receiving surface 206 is made of foam. The central portion and the lateral portions are thus made from distinct foams having different rigidities. The difference in rigidities between the central portion and the lateral portions may facilitate the occupant's immersion into the foam of the central portion while providing more rigid lateral zones which can facilitate the occupant's egress from the occupant support 102 and minimize the risk of falling off the occupant support 102.

It is contemplated that, in other embodiments, the resilient support layer of the occupant receiving surface 206 could be made of a different type of resilient material and/or could have a different construction that imparts resilience to the occupant receiving surface 206. For instance, in some embodiments, the resilient support layer of the occupant receiving surface 206 could be made of one or more air-filled pockets.

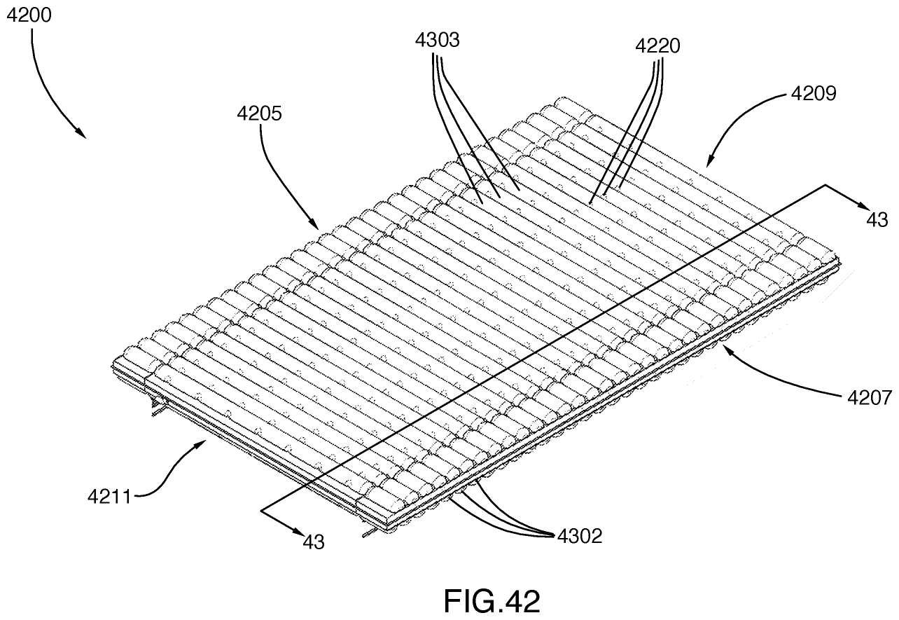

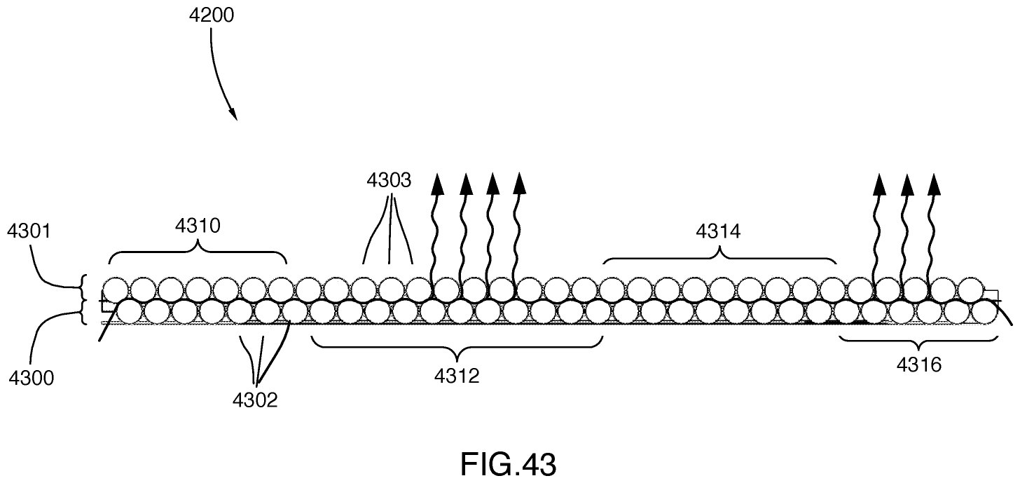

With further reference to FIGS. 42 and 43, in another embodiment the occupant support 102 has an occupant receiving surface 206 that comprises a support layer 4200 including a lower integral sheet 4300 provided with a plurality of bladders 4302, and a top integral sheet 4301 also provided with a plurality of bladders 4303. The bladders 4302 and 4303 have an elongated shape and are assembled in a side-by-side relationship to extend laterally across the support layer 4200, the bladders 4302 of the lower integral sheet 4300 being arranged in quincunx with those of the top integral sheet 4301, as best shown in FIG. 43.

In one embodiment, the lower integral sheet 4300 and the top integral sheet 4301 are attached to one another at the lateral ends 4205, 4207, proximal end 4209 and distal end 4211 (corresponding to a head region and a feet region of the occupant, respectively) to define a pocket (not shown) therebetween, the pocket defining a Low-Air-Loss (LAL) space between the lower integral sheet 4300 and the top integral sheet 4301. In this embodiment, a fluid supply (e.g., an air supply) is provided to the support layer 4200, and air travels between the lower integral sheet 4300 and the top integral sheet 4301 to exit the top surface of the top integral sheet 4301 via a plurality of pores 4220 defined in the sewing or welding lines, between adjacent bladders 4303 of the top integral sheet 4301.

It will be appreciated that release of air via the plurality of pores 4220 defined in the top integral sheet 4301 may be used to help dissipate moisture/humidity in the occupant support 102.

In another embodiment, the support layer 4200 may be separated into a plurality of zones through which the flow of air is controllable independently. For example, a head zone 4310, a torso zone 4312, a seat zone 4314 and a leg zone 4316 may be defined in the support layer 4200, each one of the head zone 4310, the torso zone 4312, the seat zone 4314 and the leg zone 4316 corresponding to a distinct microclimate managed area 301 on the receiving surface 206 of the occupant support 102. In this embodiment, the release of air via the plurality of pores 4220 towards the intermediate air diffusion layer 202 may be restricted to one of the four zones or a subset of the four zones only (e.g., the torso zone 4312 and the seat zone 4314). In other examples, the flow of air through the pores 4220 towards the intermediate air diffusion layer 202 may be routed to all four zones.

In the illustrated embodiment of FIGS. 42 and 43, the support layer 4200 is provided with 32 bladders 4302 in the lower integral layer 4300 and 32 bladders 4303 in the top integral layer 4301. In one non-limiting example, the bladders 4302, 4303 are about 2⅛ inches in diameter, and have a width of 35 inches when fully inflated to provide support layer 4200 of about 4 inches when fully inflated, since the bladders 4302, 4303 of the lower integral layer 4300 and the top integral layer 4301 are positioned in quincunx. Various other configurations may be envisaged for a particular application without departing from the scope of the present disclosure. For instance, in other embodiments, instead of being integrally formed together in a lower layer 4300 and top layer 4301, the inflatable comfort bladders 4302 and 4303 may be arranged in a unitary piece (i.e., the comfort bladders 4302, 4303 may be vertically aligned with each other).

In one embodiment, the occupant support 102 may be configured to include both the air distribution manifold 204 as well as the support layer 4200, which provides added control over the release of air towards the intermediate air diffusion layer 202. In a non-limiting example, the air distribution manifold 204 and the support layer 4200 are connected to independent air pump modules, as further discussed below, which enables the supply of air with distinct characteristics (e.g., temperature, flow, etc.) in distinct regions of the occupant support 102. In another non-limiting example, the inclusion of both the air distribution manifold 204 and the support layer 4200 in the occupant support 102 increases the humidity/moisture removal capacity of the microclimate management system 100. In still a further embodiment, an air distribution manifold and air distribution conduits similar to those shown in FIG. 4 may be used to provide air flow to the Low-Air-Loss (LAL) space between the lower integral sheet 4300 and the top integral sheet 4301 before air distribution to the intermediate air diffusion layer 202.

Referring now to FIG. 6, in a further embodiment, the microclimate management system 100 may be further provided with a bottom layer 602 disposed below the occupant support 102 for enclosing, together with the top layer 200, the occupant support 102, the intermediate air diffusion layer 202, and the bottom air distribution manifold 204 therein. As such, together, the top layer 200 and the bottom layer 602 can be said to form a cover of the mattress, with the top layer 200 being the top portion of the cover and the bottom layer 602 being the bottom portion of the cover.

In the illustrated embodiment, the bottom layer 602 has a top face 604, an opposed bottom face 606, and a peripheral wall 608 extending upwardly from the top face 604 along the periphery thereof. When disposed below the occupant support 102, the top and bottom faces 604 and 606 of the bottom layer 602 are aligned with the bottom face 320 of the occupant support 102, while the peripheral wall 608 extends along the periphery of the occupant support 102 to provide a snuggly fit. As such, the peripheral wall 608 and the top face 604 of the bottom layer 602 together define a lower cavity 610. The bottom layer 602 and the top layer 200, when mounted together, define a compartment formed by the lower cavity 610 and the upper cavity 214 for enclosing the occupant support 102, the intermediate air diffusion layer 202, and the bottom air distribution manifold 204 therein. In such arrangement, the connector 306 of the bottom air distribution manifold 204 is received in a connector opening 614 provided in the peripheral wall 608 of the bottom layer 602 instead of being disposed on the peripheral wall 212 of the top layer 200.

The bottom layer 602 may be attachable to the top layer 200. For example, the bottom layer 602 may be provided with an attachment element 612 extending at least partially along the peripheral wall 608. The attachment element 612 may cooperate with the corresponding first attachment element 216 of the top layer 200 such that the bottom layer 602 may be removable from the top layer 200. In such case, the attachment element 218 of the occupant support 102 may be omitted. The attachment elements 612, 216 may be airtight or non-airtight, as described above with respect to attaching elements 216, 218 and according to a specific application. Exemplary attachment elements 612, 216 may include a zipper, an elastic band, buttons, Velcro™ or attachment straps.

In one embodiment, the bottom layer 602 of the microclimate management system 100 is made of a fluid-resistant material.

In one embodiment, with further reference to FIGS. 35-37, a facing 3500 may be provided along the peripheral wall 212 of the top layer 200 for supporting the attachment element 216. The facing 3500 may extend around the entire periphery of the top layer 200, or around a portion thereof. While the attachment element 216 is a top half of a zipper 3700 in FIGS. 35-37, it will be appreciated that any other suitable attachment element may be used in other embodiments. When the top layer 200 is secured to the bottom layer 602 via the attachment element 216, the peripheral wall 212 of the top layer 200 forms a flap 3502 (shown flipped up and showing the inner portion of the peripheral wall 212 in FIG. 35 and shown flipped down and showing the outer portion of the peripheral wall 212 in FIG. 36) that can be flipped up to access the attachment element 216 during use.

In one embodiment, the facing 3500 is a rigidifying strip of material coupled to the top layer 200 on an inner side of the peripheral wall 212. The rigidifying strip is made of a material that is more rigid than the material of the top layer 200 such that the peripheral wall 212 is rigidified by the coupling of the rigidifying strip thereto. For example, the rigidifying strip may comprise thermoplastic polyurethane (TPU) or any other material exhibiting an elastic modulus greater than the elastic modulus of the material of the top layer 200. The rigidifying strip may have the same thickness as the material of the top layer 200, or may have a greater thickness than the material of the top layer 200. In some cases, the rigidifying strip may be more rigid than the material of the top layer 200 by virtue of its greater thickness and not necessarily because it has a greater elastic modulus.

The facing 3500 may be coupled to the top layer 200 by any suitable technique, including but not limited to welding (e.g., radiofrequency (RF) or ultrasound welding), sewing and/or other appropriate techniques.

The greater rigidity of the facing 3500 may facilitate washing of the top cover and may also enable the peripheral wall 212 of the top layer 200 to more closely conform to the shape of the underlying occupant support 102. This may be particularly true where the shape of the occupant support 102 varies along the length of the occupant support 102. Furthermore, the greater the rigidity of the facing 3500, the more precise the positioning of the attachment element 216 on the top layer 200. In addition, by providing the attachment element 216 on the rigidifying strip which is disposed on the inside of the peripheral wall 212, the attachment element 216 is not exposed on the outside of the occupant support 102, thereby minimizing the risk of liquid infiltration through the attachment element 216.

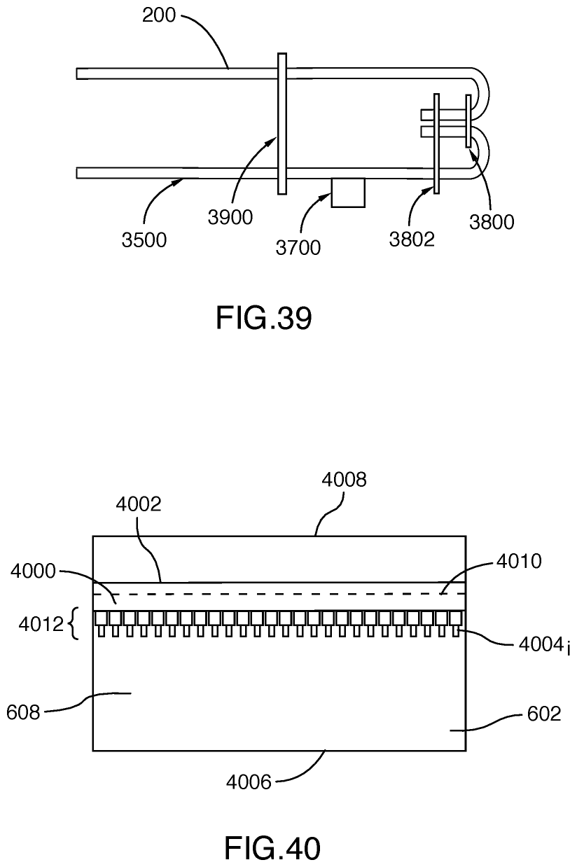

With further reference to FIGS. 38 and 39, a method for coupling the top layer 200 and the facing 3500 is shown and which includes first positioning the edge portion of the facing 3500 against an exterior surface of an edge portion of the peripheral wall 212 of the top layer 200. The edge portion of the facing 3500 is then sewn to the edge portion of the top layer 200 along a first line in order to form a first seam 3800. The facing 3500 is then folded over the first seam 3800 such that the edge portion of the facing 3500 is layered over by part of the facing 3500. This results in a folded end being formed by the facing 3500. The facing 3500 is then sewn to the top layer 200 along a second line to form a second seam 3802 that couples together the two superimposed layers of the facing 3500 to the edge portion of the top layer 200. The second seam 3802 is parallel to the first seam 3800. In some non-limiting examples, only a first seam may be formed between the facing 3500 and the top layer 200.

Further, with reference to FIG. 39, the method includes folding over the top layer 200 so that the facing 3500 overlies the peripheral wall 212. This results in the peripheral wall 212 forming a folded end. Then, the facing 3500 is welded to the peripheral wall 212 along a line distanced from the two folded ends to form a welded seam 3900. The quality of the weld at the welded seam 3900 is ensured in part by the material of the facing 3500. In one non-limiting example, the facing 3500 is a rigidifying strip made of TPU which lends itself well to welding and therefore a resistant welded seam 3900 is obtained. In other non-limiting examples, other weldable materials could be selected to obtain a similar result. Moreover, it will be appreciated that this method prevents either of the sewn first and second seams 3800, 3802 from being exposed on the outside of the occupant support 102 during use, further enhancing the washability of the occupant support 102 as well as its aesthetic.

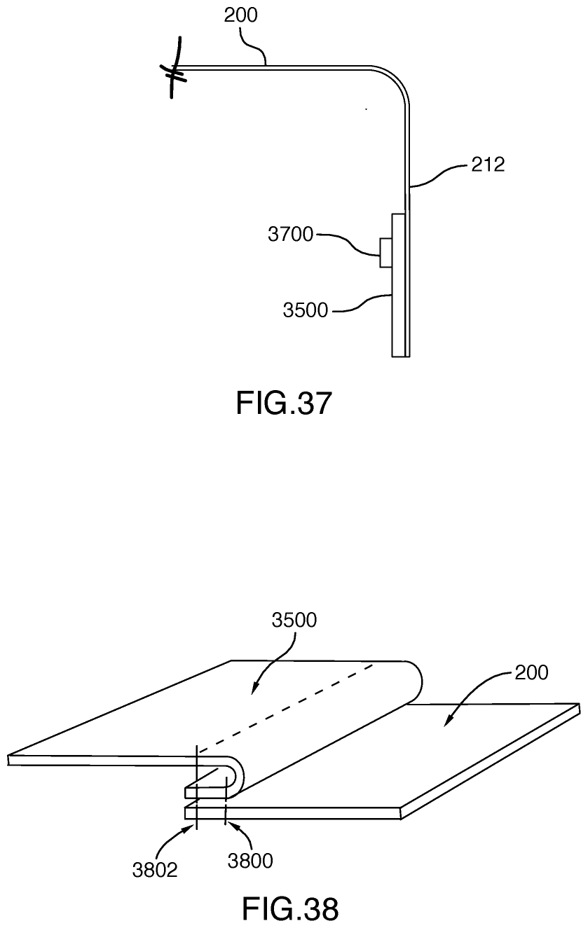

In some non-limiting examples, the facing 3500 may not be a single continuous material and may instead consist of multiple strips coupled to the top layer 200. Moreover, the attachment element 216 is preferably coupled to the facing 3500 prior to the facing 3500 being coupled to the top layer 200, but could alternatively be coupled to the facing 3500 afterwards. Also, the position of the attachment element 216 (e.g., the top half of a zipper 3700) on the facing 3500, as shown in FIGS. 37 and 39, may be different in other cases (e.g., could be positioned on the other side of the welded seam 3900).

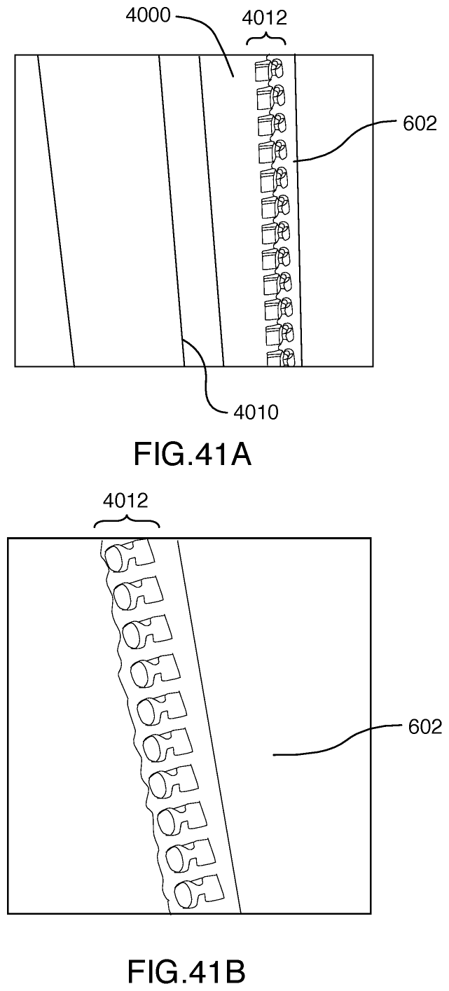

With further reference to FIGS. 40, 41A and 41B, the manner in which the attachment element 612 is attached to the bottom layer 602 of the mattress will now be described. In this embodiment, the attachment element 612 is the bottom half of a zipper 4000 that is complementary to the top half 3700 provided on the top layer 200. As can be seen in FIG. 41B, the bottom half of the zipper 4000 is sewn to the bottom layer 602 in such a way as to conceal the seam formed between the bottom zipper half 4000 and the bottom layer 602. In some embodiments, the bottom half of the zipper 4000 could instead be attached to the occupant support 102 instead of to the bottom layer 602 (e.g., in cases where the bottom layer 602 is omitted).

As shown in FIG. 40, the bottom half of the zipper 4000 is sewn to the peripheral wall 608 of the bottom layer 602 along a tape 4002 of the zipper 4000 with the teeth 4004ᵢ of the zipper facing downward toward the bottom end 4006 of the bottom layer 602. While this orientation of the bottom half of the zipper 4000 has the teeth 4004ᵢ facing away from the top layer 200, it allows the sewn seam 4010 between the tape and the bottom layer to be hidden once both zipper halves are engaged by the slider (not shown) such that the teeth of both zipper halves are engaged with each other. Notably, as can be seen in FIGS. 41A-B, when the bottom layer 602 and the top layer 200 are fastened to each other via the slider, the orientation of the bottom half of the zipper is reversed (i.e., the tape is oriented downwardly and the teeth are oriented upwardly) such that a portion of the tape hides the seam line.

This allows a better finish and minimizes the risk of infiltration of liquid inside the mattress.

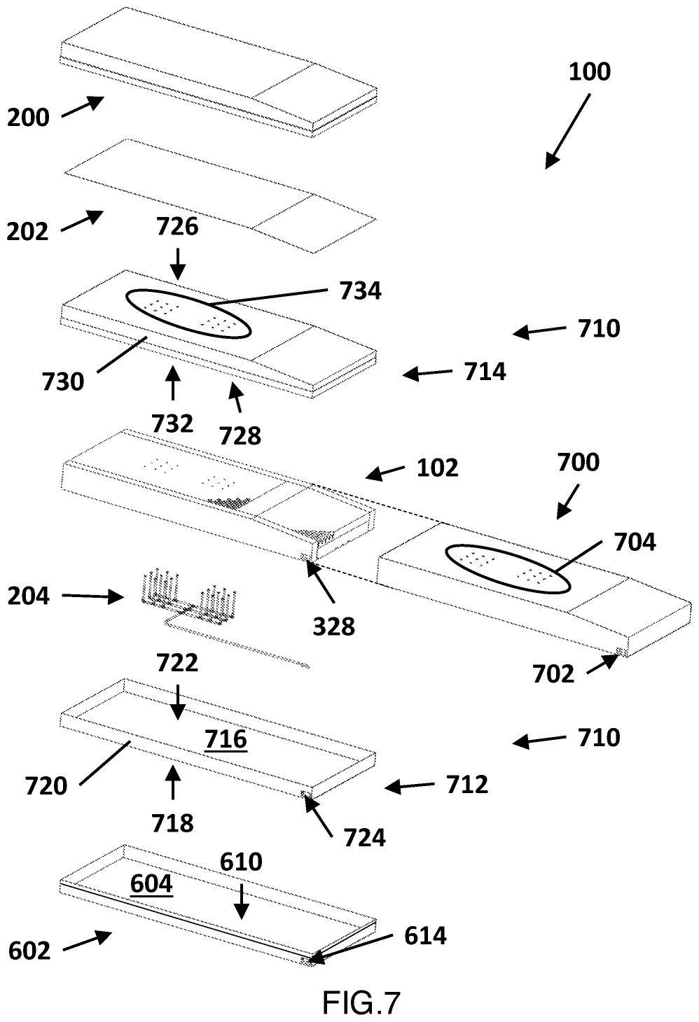

Referring now to FIG. 7, in a further embodiment, the microclimate management system 100 may further be provided with a fire-resistant envelope 700 for enclosing the occupant support 102 and the bottom air distribution manifold 204 therein such that same are protected against fire.

In the illustrated embodiment, the fire-resistant envelope 700 is provided as a one-piece slide-on sleeve having a rear opening (not shown) for inserting the occupant support 102 and the bottom air distribution manifold 204 in the fire-resistant envelope 700. The opening may be provided with a closing means (not shown), such as a zipper, an elastic band, buttons, Velcro™ or attachment straps. The fire-resistant envelope 700 may be snuggly fitted around the occupant support 102 and the previously installed bottom air distribution manifold 204.

The fire-resistant envelope 700 may be provided with a first plurality of air circulation apertures 704 each operatively arranged to cooperate with a corresponding distribution port 314 of the bottom air distribution manifold 204. Such air circulation apertures 704 enable free air circulation through the fire-resistant envelope 700 towards the intermediate air diffusion layer 202. Alternatively, the fire-resistant envelope 700 may be made of a material that allows the passage of air therethrough such that no air circulation apertures 704 have to be provided.

Still referring to FIG. 7, in a further embodiment, the microclimate management system 100 is further provided with a fluid-resistant envelope 710 for enclosing the occupant support 102, the bottom air distribution manifold 204, and the fire-resistant envelope 700 therein such that the same are protected against liquid spillage.

In the illustrated embodiment, the fluid-resistant envelope 710 is provided with a bottom portion 712 and a top portion 714 attachable together and disposed below and above, respectively, the assembly of the occupant support 102, the bottom air distribution manifold 204, and the fire-resistant envelope 700. The bottom portion 712 of the fluid-resistant envelope 710 has a top face 716, an opposed bottom face 718, and a peripheral wall 720 extending upwardly from the top face 716 along the periphery thereof. As such, the peripheral wall 720 and the top face 716 of the bottom portion 712 together define a lower cavity 722.

The top portion 714 of the fluid-resistant envelope 710 has a top face 726, an opposed bottom face 728, and a peripheral wall 730 extending downwardly from the bottom face 728 along the periphery thereof. As such, the peripheral wall 730 and the bottom face 728 of the top portion 714 together define an upper cavity 732. The top portion 714 is further provided, on the top face 726, with a second plurality of air circulation apertures 734 each operatively connected to a corresponding distribution port 314 of the bottom air distribution manifold 204 and a corresponding air circulation aperture 704 of the fire-resistant envelope 700, if any. Such air circulation apertures 734 enable free air circulation through the fluid-resistant envelope 710 towards the intermediate air diffusion layer 202. For example, the air circulation apertures 734 may be sealingly connected to the distribution ports 314 of the air distribution conduits 302 to provide protection to the occupant support 102 against liquid spillage. When mounted together, the bottom portion 712 and the to top portion 714 define a compartment formed by the lower cavity 722 and the upper cavity 732 for enclosing the occupant support 102 assembly previously described.

In one embodiment, the bottom portion 712 and the top portion 714 of the fluid-resistant envelope 710 may be attachable together with corresponding attachment elements cooperating together, similarly to what have been described above for the attachment of the top layer 200 to the bottom layer 602.

In another embodiment, the bottom portion 712 may be omitted and the top portion 714 of the fluid-resistant envelope 710 is attachable to the bottom layer 602 with an appropriate attachment element.

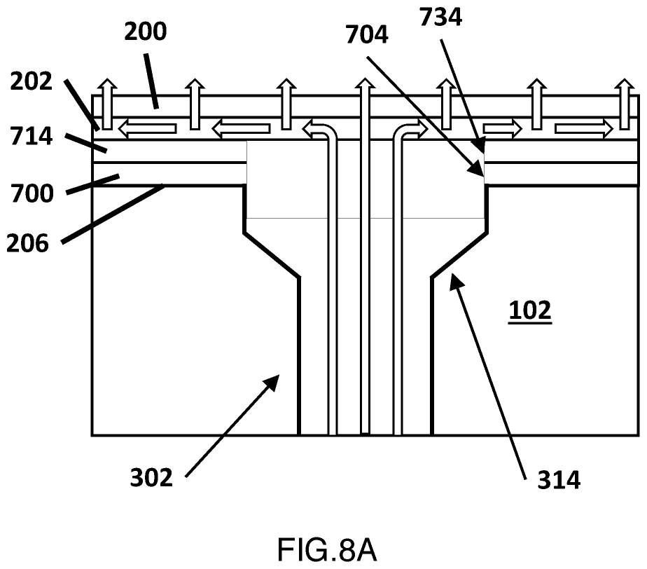

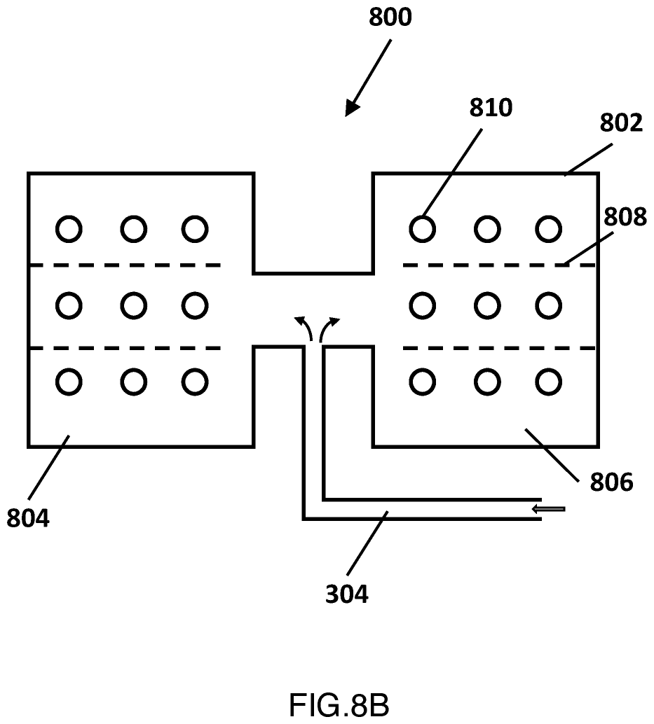

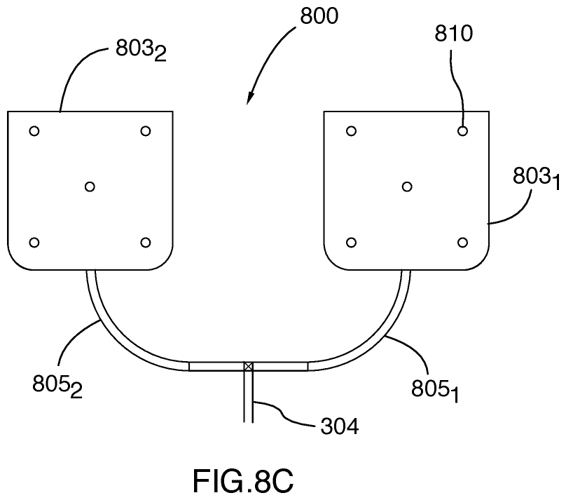

FIG. 8A illustrates a layered arrangement in which the fire-resistant envelope 700, the top portion 714 of the fluid-resistant envelope 710, the intermediate air diffusion layer 202, and the top layer 200 are disposed atop one another.

It will be appreciated that any other arrangement of the fire-resistant envelope 700 and the fluid-resistant envelope 710 may be contemplated without departing from the scope of the present disclosure. For example, the fire-resistant envelope 700 may be provided as two or more portions thereof which are attachable to one another, similarly to what has been described hereinbefore for the fluid-resistant envelope 710. The fluid-resistant envelope 710 may be provided as a one-piece slide-on sleeve, similarly to what have has described hereinbefore for the fire-resistant envelope 700. The fluid-resistant envelope 710 may first be mounted directly with the occupant support 102 and the bottom air distribution manifold 204, and then the fire-resistant envelope 700 may be mounted with the fluid-resistant envelope 710.

In one embodiment described above, the connector 306 of the bottom air distribution manifold 204 is received in the connector opening 614 provided in the peripheral wall 608 of the bottom layer 602 (shown in FIG. 6). In a further embodiment, as illustrated in FIG. 7, the connector 306 may be arranged to be received in a connector opening 328 provided on the periphery of the occupant support 102. In such a case, corresponding openings 702 and 724 are respectively provided on the fire-resistant envelope 700 and the fluid-resistant envelope 710 and are used in addition to the connector opening 614 of the bottom layer 602, as it should become apparent to the skilled addressee.

Referring now to FIG. 8B, there is shown another bottom air distribution manifold 800 of another microclimate management system, according to another embodiment. In this embodiment, instead of the horizontal supply hose extensions 308 previously described with reference to FIG. 3A, an air impermeable jacket or envelope 802 is used for supplying air to the air distribution conduits 302. In the illustrated embodiment, the envelope 802 has a first and a second portion 804, 806, each being provided with nine connectors 810 welded thereto for connecting the air distribution conduits 302 previously described. The envelope 802 may be installed below the occupant support 102, as previously described. In one embodiment, a recess (not shown) is provided in the bottom face 320 of the occupant support 102 to receive the envelope 802 therein. In one embodiment, the envelope 802 is made of two layers superimposed and joined together, for example by welding. In a further embodiment, sealing lines 808 are provided in each of the first and second portions 804, 806 to better distribute the air flow therein, similarly to the previously described horizontal supply hose extensions 308. The sealing lines may be obtained by welding or other appropriate techniques.

In yet a further embodiment, the first and second portions 804, 806 of the envelope 802 are each provided with a three-dimensional spacer, or with at least one fabric exhibiting a dimensional profile, or with any other resilient or crushable material such as a foam or a thick fibered fabric for preventing or at least substantially reducing any undesired collapsing that may occur and block the passage of air therethrough.

Referring now to FIG. 8C, there is shown another bottom air distribution manifold 800 of another microclimate management system, according to another embodiment. In this embodiment, instead of the horizontal supply hose extensions 308 previously described with reference to FIG. 3A, two air impermeable jackets or envelopes 803₁ and 803₂, are used for supplying air to the air distribution conduits 302. In the illustrated embodiment, each one of the envelopes 803₁ and 803₂ is being provided with five connectors 810 welded thereto for connecting the air distribution conduits 302 previously described. The envelopes 803₁ and 803₂ may be installed below the occupant support 102, as previously described. In one embodiment, a recess (not shown) is provided in the bottom face 320 of the occupant support 102 to receive the envelopes 803₁ and 803₂ therein. In one embodiment, each one of the envelopes 803₁ and 803₂ is made of two layers superimposed and joined together, for example by welding. In this embodiment, the main supply hose 304 is split into two subsidiary supply hoses 805₁ and 805₂ which are in fluid communication with the envelopes 803₁ and 803₂, respectively.

In yet a further embodiment, the envelopes 803₁ and 803₂ are each provided with a three-dimensional spacer, or with at least one fabric exhibiting a dimensional profile or with any other resilient or crushable material such as a foam or a thick fibered fabric for preventing or at least substantially reducing any undesired collapsing that may occur and block the passage of air therethrough.

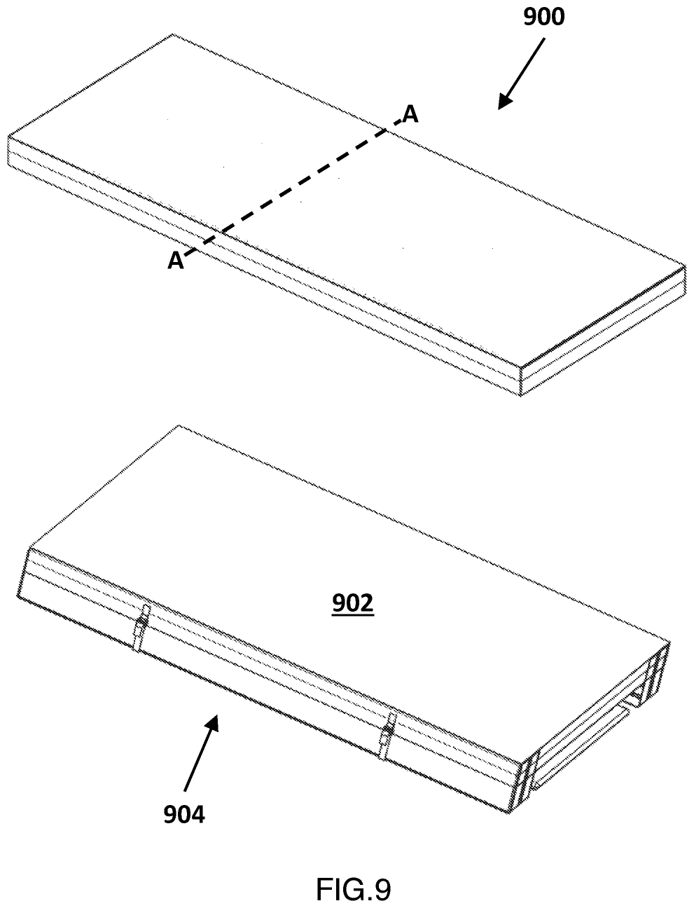

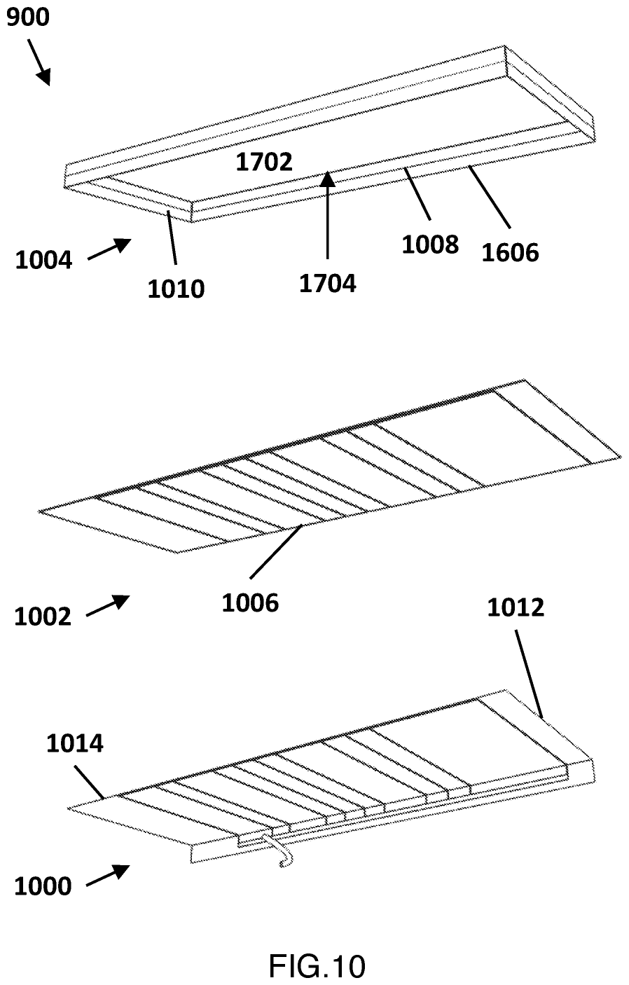

Referring now to FIGS. 9 and 10, a microclimate management overlay 900 mountable over an occupant receiving surface 902 of a corresponding occupant support 904 will now be described, according to one embodiment of a second aspect of the present disclosure. The microclimate management overlay 900 may be used with various types of occupant supports, such as mattresses made of resilient material like foam and/or made of fluid bladders, as it will become apparent below.

As better illustrated in FIG. 10, the microclimate management overlay 900 is provided with a bottom air distribution assembly 1000, an intermediate air diffusion layer 1002, and atop layer 1004. More particularly, the bottom air distribution assembly 1000 is mountable over the occupant receiving surface 902 of the occupant support 904, the intermediate air diffusion layer 1002 is operatively mountable above the bottom air distribution assembly 1000, and the top layer 1004 is mountable above the intermediate air diffusion layer 1002. When mounted together, the bottom air distribution assembly 1000 is adapted to distribute air to the intermediate air diffusion layer 1002 where air diffuses therethrough, as it will become apparent hereinafter.

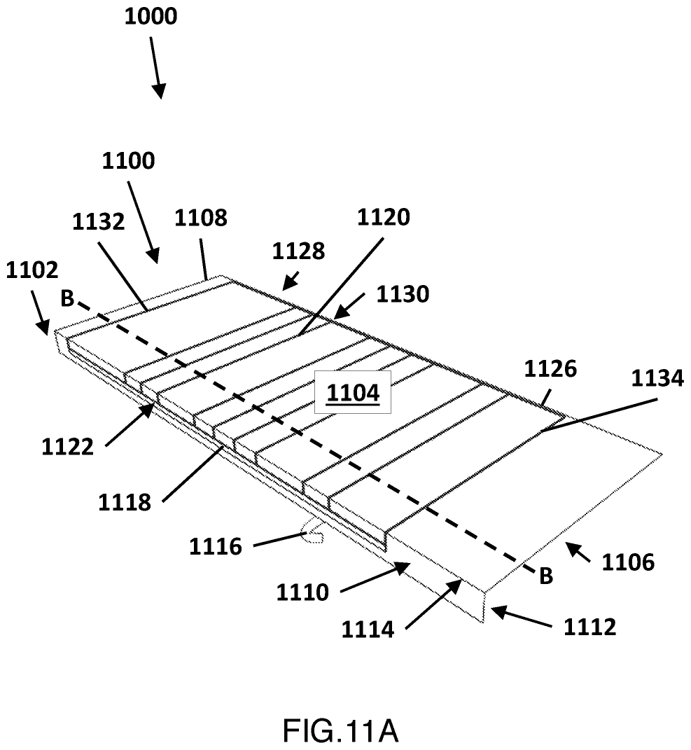

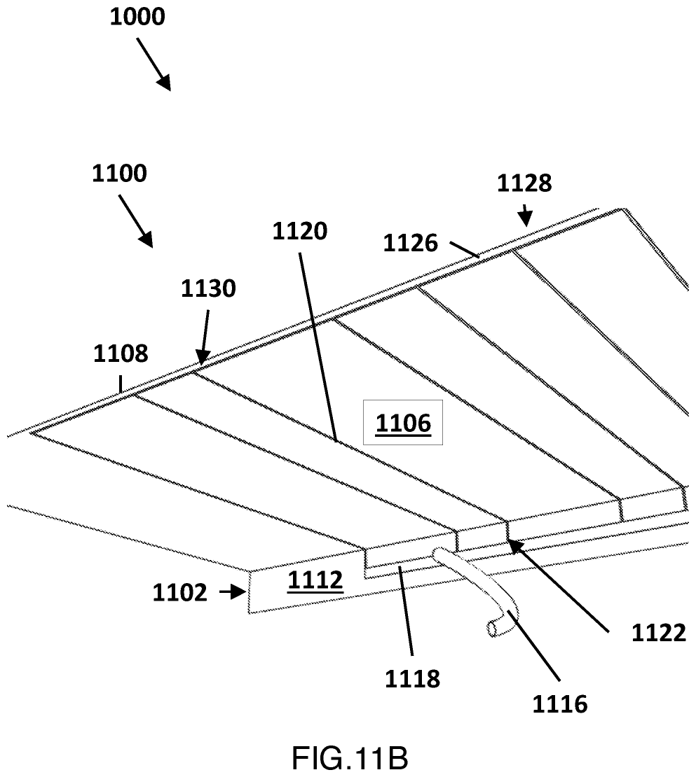

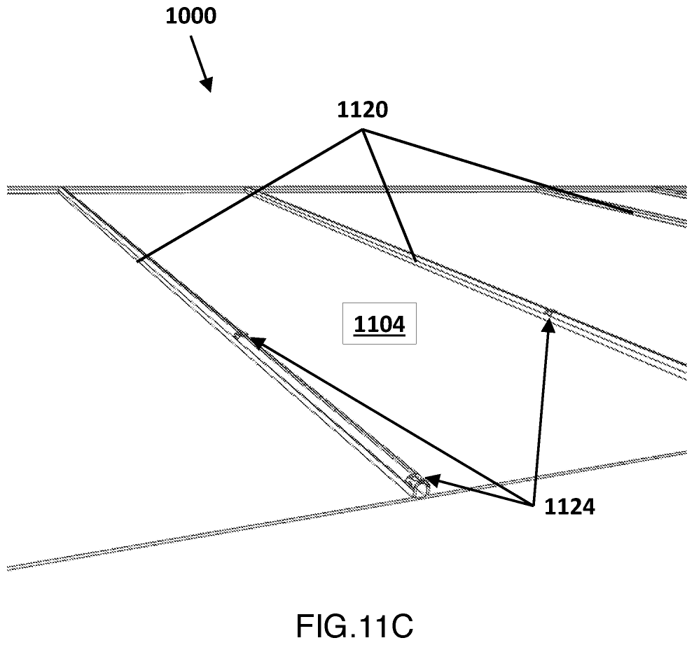

FIGS. 11A and 11B illustrate one embodiment of the bottom air distribution assembly 1000 that is provided with a horizontal section 1100 devised to rest on the occupant receiving surface 902 of the occupant support 904 and a vertical longitudinal section 1102 attached to a longitudinal end 1114 of the horizontal section 1100. The horizontal section 1100 and the vertical longitudinal section 1102 may together form an integral, monolithic piece. More particularly, the horizontal section 1100 has an upper face 1104, an opposed lower face 1106 and a periphery 1108 therearound. The vertical section 1102 has an external face 1110 and an opposed internal face 1112. The vertical section 1102 extends downwardly and substantially perpendicularly from the periphery 1108 of the horizontal section 1100, on the longitudinal end 1114.

The illustrated bottom air distribution assembly 1000 is provided with a supply hose 1116 connectable to an air supply module (not shown) for supplying air thereto. The bottom air distribution assembly 1000 also has a first longitudinal air supply channel 1118 extending longitudinally along the external face 1110 of the vertical section 1102 and operatively connected to the air supply hose 1116. The bottom air distribution assembly 1000 is also provided with a plurality of elongated air distribution channels 1120 extending transversally on the upper face 1104 of the horizontal section 1100 and on the external face 1110 of the vertical section 1102, each being operatively connected on a first end 1122 to the first longitudinal air supply channel 1118.

As better shown in FIG. 11C, each of the elongated air distribution channels 1120 is provided with a corresponding plurality of air distribution apertures 1124 extending therealong and directed substantially upwardly towards the intermediate air diffusion layer 1002 that is disposed above. These air distribution apertures 1124 enable to distribute air upwardly therethrough to the intermediate air diffusion layer 1002.

The air distribution apertures 1124 may be arranged according to a predetermined pattern including one or more group of air distribution apertures 1124, which defines one or more corresponding therapeutic zone of a microclimate managed area on the top layer 1004. For example, a first group of air distribution apertures 1124 may be used for the occupant's back region while a second group may be used for the occupant's seat region, for preventing and/or minimizing skin wounds, pressure ulcers, and/or bedsores generally associated with extended bed rest.

It will be appreciated that any number and any configuration of the air distribution apertures 1124 may be contemplated without departing from the scope of the present disclosure. For example, the air distribution apertures 1124 may be arranged on the sides of the elongated air distribution channels 1120 instead of on the top thereof as in the illustrated embodiment. Moreover, the elongated air distribution channels 1120 may be omitted and other convenient arrangements enabling to supply air through the air distribution apertures 1124 therethrough to the intermediate air diffusion layer 1002 may be considered. The various therapeutic zones may also be differently designed and/or be operated simultaneously or independently, according to a specific application.

Referring back to FIGS. 11A and 111B, in one embodiment, the bottom air distribution assembly 1000 may be further provided with a second longitudinal air supply channel 1126 opposite the first longitudinal air supply channel 1118 and operatively connected to the elongated air distribution channels 1120. More particularly, the second longitudinal air supply channel 1126 extends longitudinally along a second longitudinal side 1128 opposite to the first longitudinal side 1114 of the horizontal section 1100, and is operatively connected to a second end 1130 of each of the elongated air distribution channels 1120 for circulating air therethrough.

The dual operative connection of the elongated air distribution channels 1120 to the first and second longitudinal air supply channels 1118 and 1126 enables air to be conveyed to the elongated air distribution channels 1120 at each of the first and second ends 1122, 1130 thereof. In the event that the weight of an occupant collapses and partially blocks a portion of the elongated air distribution channels 1120, the dual operative connection ensures that air is still conveyed on others portions of the elongated air distribution channels 1120.

In one embodiment, the bottom air distribution assembly 1000 may be further provided with a pair of interconnecting air channels 1132, 1134 (best shown in FIG. 11A), each operatively connected between the first and the second longitudinal air supply channels 1118 and 1126. Each of the interconnecting air channels 1132, 1134 is void of air distribution apertures 1124 to better circulate air between the first and the second longitudinal air supply channels 1118, 1126.

In another embodiment, the second longitudinal air supply channels 1126 may be provided with another air supply hose (not shown) for supplying air thereto.

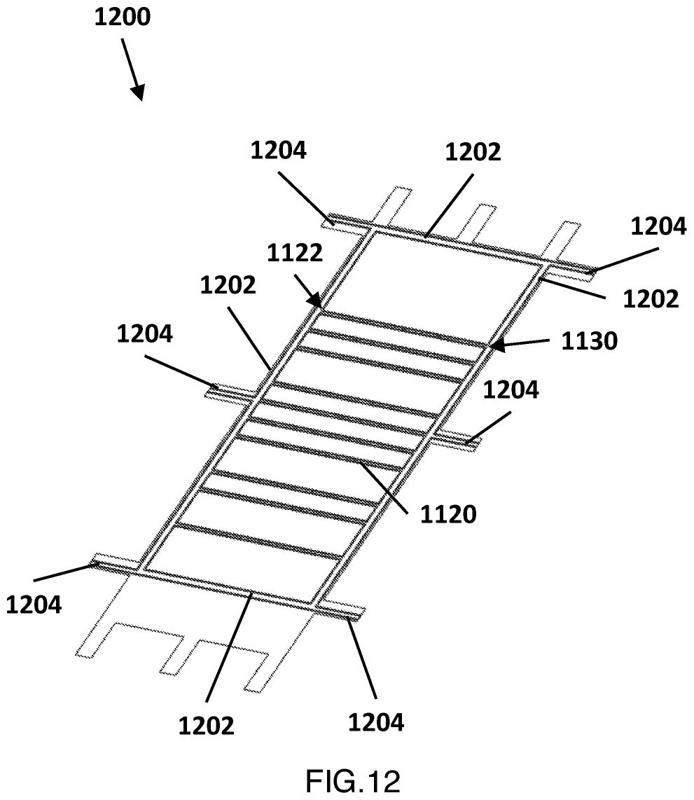

FIG. 12 illustrates another embodiment of a bottom air distribution assembly 1200 which is provided with a peripheral air supply channel 1202 extending along the periphery thereof and operatively connected to the elongated air distribution channels 1120, each having a corresponding plurality of air distribution apertures 1124 (not shown), as previously described. The peripheral air supply channel 1202 is operatively connected to a plurality of air inlet channels 1204, four in the illustrated embodiment distributed at each corner, for supplying air to the bottom air distribution assembly 1200. The peripheral air supply channel 1202 also provides a dual operative connection to each of the elongated air distribution channels 1120 through their respective first and second ends 1122, 1130.

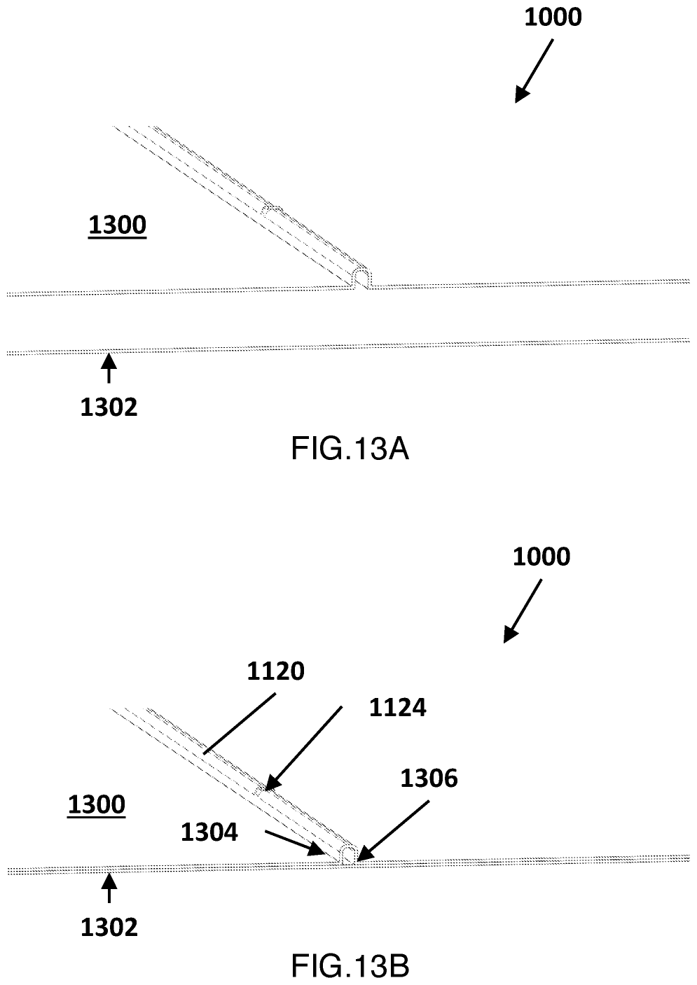

In one embodiment, the bottom air distribution assemblies 1000, 1200 may have a two-layer construction. For example, as illustrated in the embodiment of FIGS. 13A and 13B, two sheets of flexible material 1300, 1302 are superimposed and joined together such that, in some embodiments, two adjacent weld lines 1304, 1306 form one elongated air distribution channel 1120 therebetween.

In one embodiment, one of several portions of the bottom air distribution assemblies 1000, 1200 may be provided with a three-dimensional spacer, or with at least one fabric exhibiting a dimensional profile or with any other resilient or crushable or compressible material such as a foam or a thick fibered fabric for preventing or at least reducing any undesired collapsing that may occur and block the passage of air therethrough. For example, in one embodiment similar to the one illustrated in FIG. 11A, the supply hose 1116, the first and second longitudinal air supply channels 1118 and 1126, and the elongated air distribution channels 1120 of the bottom air distribution assembly 1000 each have a three-dimensional spacer or at least one fabric exhibiting a dimensional profile. In another embodiment similar to the one illustrated in FIG. 12, the air inlet channels 1204, the peripheral air supply channel 1202, and the elongated air distribution channels 1120 of the bottom air distribution assembly 1200 are provided with a three-dimensional spacer or at least one fabric exhibiting a dimensional profile.

It will be appreciated that any other arrangement of the bottom air distribution assemblies 1000, 1200 may be contemplated without departing from the scope of the present disclosure. In the case of the air distribution assembly 1000, for example, the vertical section 1102 may extend along any side of the periphery 1108 of the horizontal section 1100. The first longitudinal air supply channel 1118 may extend along any one of the external and internal faces 1110 and 1112 of the vertical section 1102. The second longitudinal air supply channel 1126 may also extend along any side of the horizontal section 1100. The elongated air distribution channels 1120 may extend longitudinally or transversally along any of the upper and lower faces 1104 and 1106 of the horizontal section 1100, as long as the air distribution apertures 1124 are adapted for distributing air to the intermediate air diffusion layer 1002. The air distribution apertures 1124 may be directed sideway along the elongated air distribution channels 1120 instead of atop thereof, as previously mentioned. The bottom air distribution assembly 1000 may also be provided without the vertical section 1102 and only with the horizontal section 1100 having the second longitudinal air supply channel 1126 operatively connected to a supply hose.

As previously mentioned with reference to FIG. 10, the intermediate air diffusion layer 1002 is operatively mountable above the bottom air distribution assembly 1000 such that, when mounted together, the bottom air distribution assembly 1000 enables distribution of air to the intermediate air diffusion layer 1002.

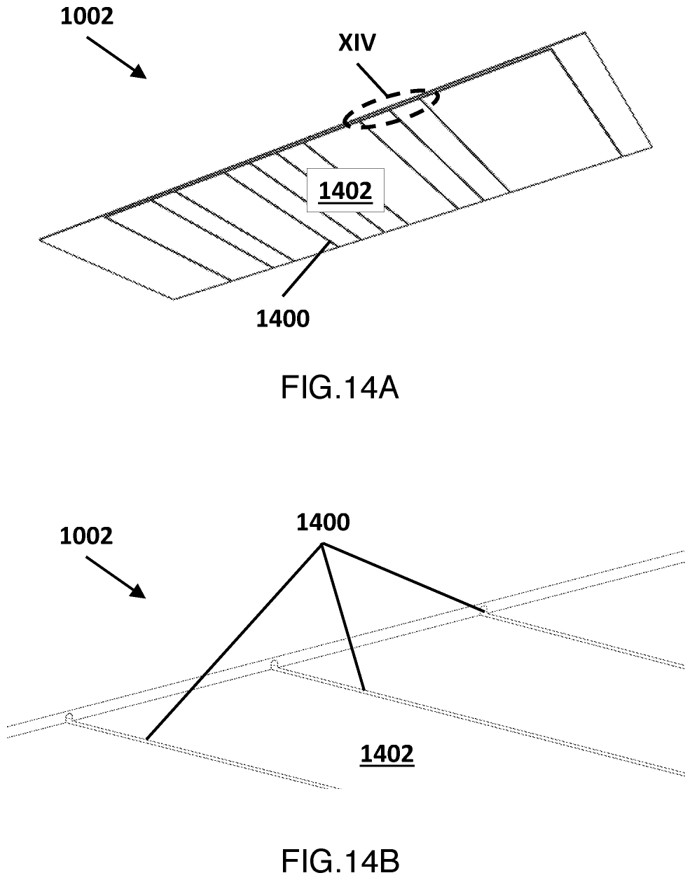

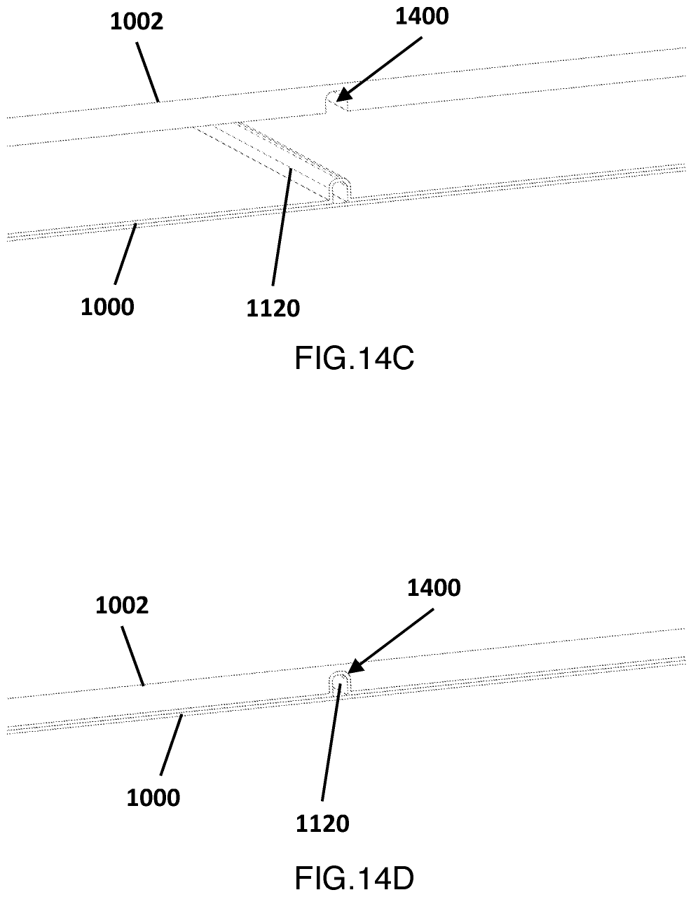

Referring now to FIGS. 14A to 14D, in one embodiment, the intermediate air diffusion layer 1002 is provided with a plurality of grooves 1400 extending transversally along a bottom face 1402 thereof. The grooves 1400 are sized and shaped for receiving the corresponding plurality of elongated air distribution channels 1120 therein when the intermediate air diffusion layer 1002 is mounted on the bottom air distribution assembly 1000 (best shown in FIGS. 14 C and 14D). The intermediate air diffusion layer 1002 may be further provided with a longitudinal groove (not shown), extending along a peripheral side thereof, which is sized and shaped for receiving the corresponding second longitudinal air supply channel 1126 therein. When mounted to the bottom air distribution assembly 1200 of FIG. 12, the intermediate air diffusion layer 1002 may be further provided with a peripheral groove (not shown), extending along the periphery thereof, which is sized and shaped for receiving the corresponding peripheral air supply channel 1202 therein.

Referring back to FIG. 10, in one embodiment, the intermediate air diffusion layer 1002 may be attachable to the top layer 1004. For example, the intermediate air diffusion layer 1002 may be provided with an attachment element 1006 extending at least partially along the periphery thereof. The attachment element 1006 may cooperate with a corresponding first attachment element 1008 provided on the top layer 1004 and extending at least partially along a peripheral wall 1010 thereof such that the intermediate air diffusion layer 1002 may be removable from the top layer 1004. Exemplary attachment elements 1006, 1008 may include a zipper, an elastic band, buttons, Velcro™ or attachment straps for example. Alternatively, the intermediate air diffusion layer 1002 may be permanently attached to the top layer 1004, such as by radiofrequency (RF) or ultrasound welding, sewing or any appropriate techniques.

In another embodiment, the intermediate air diffusion layer 1002 may be attachable to the bottom air distribution assembly 1000. For example, the attachment element 1006 of the intermediate air diffusion layer 1002 may cooperate with a corresponding attachment element 1012 provided on the bottom air distribution assembly 1000 and extending at least partially along the periphery thereof such that the intermediate air diffusion layer 1002 may be removable from the bottom air distribution assembly 1000. Exemplary attachment elements 1006, 1012 may include a zipper, an elastic band, buttons, Velcro™ or attachment straps. Alternatively, the intermediate air diffusion layer 1002 may be permanently attached to the bottom air distribution assembly 1000, either along a portion of the periphery thereof or on the upper face 1104 of the horizontal section 1100 (shown in FIG. 11A), such as by radiofrequency (RF) or ultrasound welding, sewing, and the like.

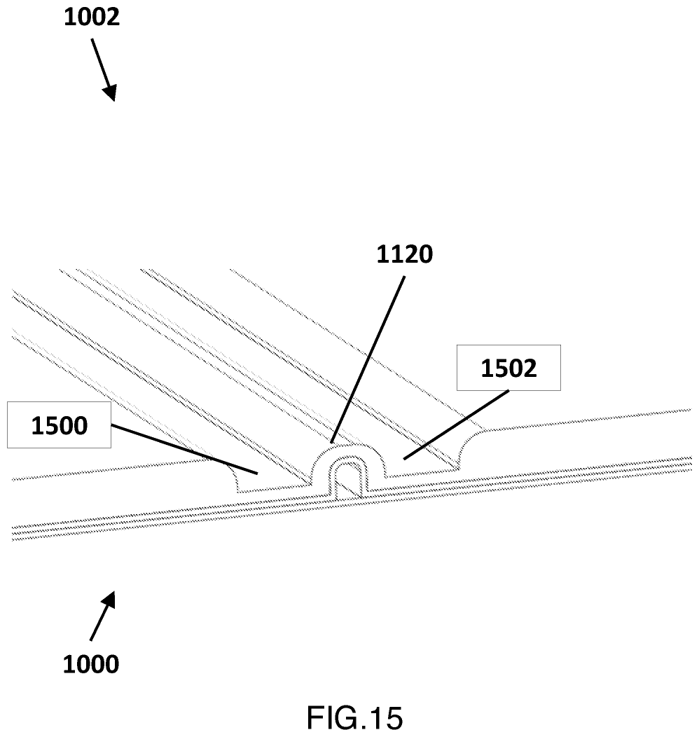

FIG. 15 illustrates another intermediate air diffusion layer 1002 assembled to the bottom air distribution assembly 1000 to form a single monolithic assembly, according to one embodiment. For this purpose, the intermediate air diffusion layer 1002 is superimposed and joined to the air distribution assembly 1000 such that two adjacent weld lines 1500, 1502 form one elongated air distribution channel 1120 therebetween.

It will be appreciated that any other arrangement of the intermediate air diffusion layer 1002 may be contemplated without departing from the scope of the present disclosure. For example, the grooves 1400 (shown in FIG. 14A) of the intermediate air diffusion layer 1002 may extend longitudinally or may have a more complex shape enabling to define a specific microclimate managed area.

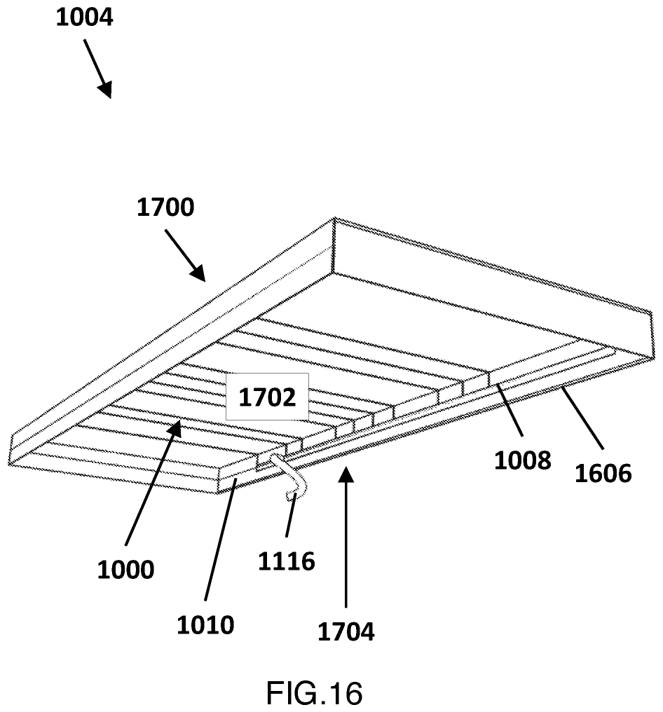

Referring back to FIG. 10 and also to FIG. 16, the top layer 1004 is mountable above the intermediate air diffusion layer 1002 and encloses the same with the bottom air distribution assembly 1000. The top layer 1004 has a top face 1700, an opposed bottom face 1702 and a peripheral wall 1010 extending downwardly which define an upper cavity 1704 for receiving the intermediate air diffusion layer 1002 therein. When mounted together, the top layer 1004 and the bottom air distribution assembly 1000 define a compartment formed by the upper cavity 1704 and the upper face 1104 of the horizontal section 1100 of the bottom air distribution assembly 1000 for enclosing the intermediate air diffusion layer 1002 therein.

In one embodiment, the top layer 1004 may be attachable to the bottom air distribution assembly 1000. For example, the top layer 1004 may be provided with a second attachment element 1606 extending at least partially along the peripheral wall 1010. The second attachment element 1606 may cooperate with a corresponding attachment element 1014, shown in FIG. 10, provided on the bottom air distribution assembly 1000 and extending at least partially along the periphery thereof such that the top layer 1004 may be removable from the bottom air distribution assembly 1000. The attachment elements 1606, 1014 may be airtight or non-airtight such that air supplied to the microclimate management overlay 900 during operation may be evacuated at least partially therethrough. Exemplary attachment elements 1606, 1014 may include a zipper, an elastic band, buttons, Velcro™ or attachment straps.

In another embodiment, the microclimate management overlay 900 may be further provided with a bottom layer (not shown) removably attachable to the top layer 1004 so that the occupant support 904 is enclosed in a compartment formed by the cavity 1704 and the bottom layer. In one embodiment, the bottom layer is liquid impermeable.

The top layer 1004 of the microclimate management overlay 900 is made of a material similar to the one described for the top layer 200 of the microclimate management system 100 hereinbefore.

In operation, the supply hose 1116, which may be operatively connected to a blower or a pump, conveys air to at least one of the first and second longitudinal air supply channels 1118 and 1126 and the elongated air distribution channels 1120. Alternatively, in the embodiment illustrated in FIG. 12, air is supplied to the air inlet channels 1204, the peripheral air supply channel 1202, and the elongated air distribution channels 1120.

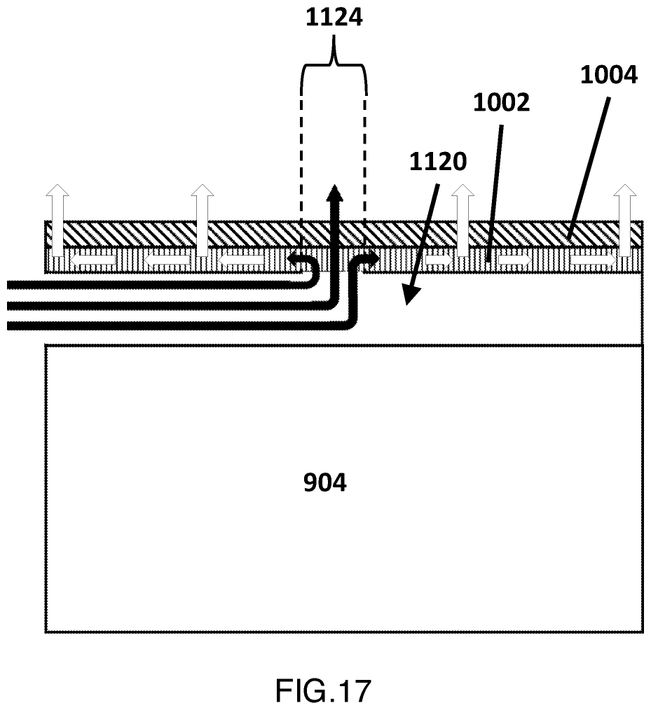

More particularly, as illustrated in the embodiment of FIG. 17, air from the elongated air distribution channels 1120 flows through the air distribution apertures 1124 to be distributed to the intermediate air diffusion layer 1002. Air then diffuses in the intermediate air diffusion layer 1002 and can permeate through the top layer 1004 towards an occupant of the occupant support 904. Air so permeated may help to regulate the microclimate environment of the occupant, such as by evaporating occupant's humidity and/or reducing occupant's body surface temperature.

In one embodiment, the microclimate management overlay 900 may be configured such that air that is supplied to the air distribution assembly 1000 does not permeate substantially through the top layer 1004, but is rather evacuated through the attachment elements 1606, 1014, which provide a non-airtight attachment. In a further embodiment not illustrated, the microclimate management overlay 900 may be further provided with an air exhaust to further facilitate air evacuation therethrough. For example, the air exhaust may be provided on the peripheral wall 1010 of the top layer 1004, or elsewhere on the microclimate management overlay 900. In operation, humidity of the occupant lying on the occupant support 904 permeates through the top layer 1004 into the intermediate air diffusion layer 1002 and is evacuated with the air being evacuated through the non-airtight attachment elements 1606, 1014 and/or the air exhaust. Such permeation and evacuation of occupant's humidity may also reduce occupant's body surface temperature.

The skilled addressee will appreciate that the intermediate air diffusion layer 1002 may have similar constructions that the ones previously described for the intermediate air diffusion layer 202.

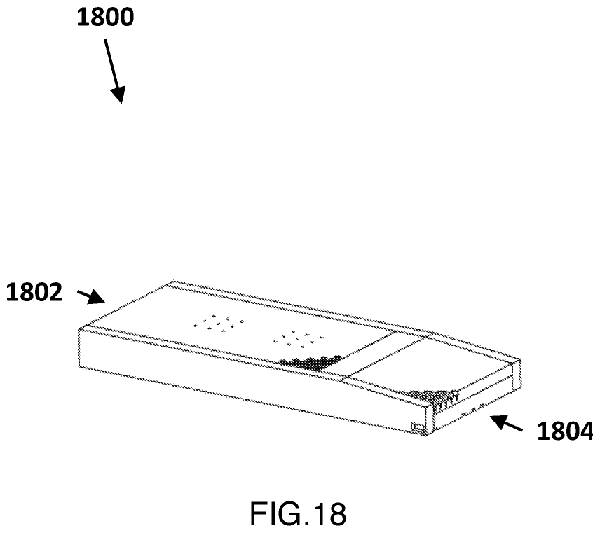

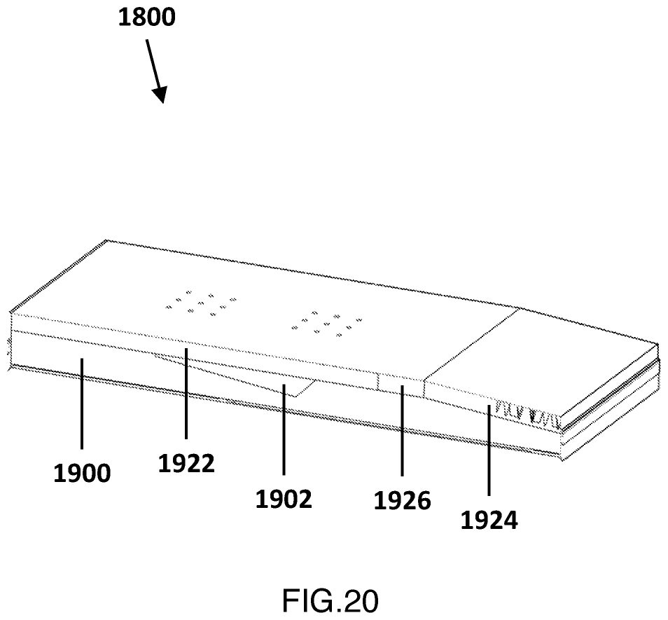

Reference is now made to FIGS. 18 to 20 showing a foam support 1800, according to one embodiment of a third aspect of the present disclosure. As it will become apparent hereinafter, the foam support 1800 is designed to enable some of the pressure-associated forces produced by the weight of an occupant lying thereon to be better distributed for reducing and/or mitigating pressure points between the occupant and the foam support 1800.

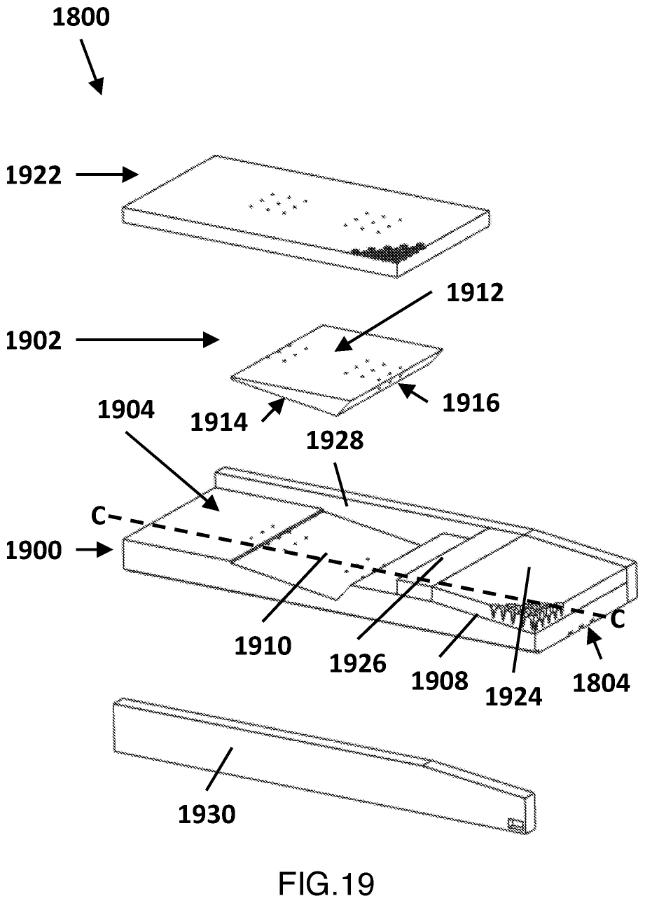

In the illustrated embodiment, as better shown in FIG. 19, the foam support 1800 has a base foam 1900 having atop surface 1904 and a cut-out portion 1910 extending therefrom. The foam support 1800 also has a seat foam insert 1902 positioned in the cut-out portion 1910. In the illustrated embodiment, the cut-out portion 1910 fully spans transversally across the base foam 1900 and is positioned therealong to receive the seat of an occupant lying on the foam support 1800. The cut-out portion 1910 substantially defines a triangular shape with the top surface 1904 and has a predetermined slopped depth that is higher at the foot end 1804 of the foam support 1800.

The seat foam insert 1902 has a triangular shape that fits into the cut-out portion 1910 and matches it shape to define a flat surface with the top surface 1904.

In the illustrated embodiment, the foam support 1800 has a slopped feet section 1908. The foam support 1800 also has additional substantially flat top foam sections arranged in an adjacent manner on the top surface 1904 for defining a flat occupant receiving surface. More specifically, the foam support 1800 has a top foam feet section 1924 disposed above the feet section 1908, a top foam calf section 1926 disposed on the top surface 1904 adjacent the top foam feet section 1924, and atop foam body section 1922 also disposed on the top surface 1904 adjacent the top foam calf section 1926 and sized to longitudinally extend fully on the seat foam insert 1902 and further away to the calf section of an occupant. The illustrated foam support 1800 is also provided with a pair of left and right foam bolsters 1928, 1930 each longitudinally disposed along a corresponding left and right side of the foam support 1800 (shown in FIG. 19).

In one embodiment, the base foam 1900, the seat foam insert 1902, the top foam body section 1922, the top foam feet section 1924, the top foam calf section 1926, as well as the left and right foam bolsters 1928 and 1930 are attached together permanently by, e.g., an adhesive, a bonding agent, or a heating process as non-limitative examples, or non-permanently by, for example, a hook and loop material or other releasable fastener.

Alternatively or additionally, the base foam 1900, the seat foam insert 1902, the top foam body section 1922, the top foam feet section 1924, the top foam calf section 1926, as well as the left and right foam bolsters 1928 and 1930 can be assembled and held together by a four-way or two-way stretchable liner that is snuggly fitted therearound.

In some embodiments, the liner may be formed from a gas permeable material that prevents liquids from passing through but allows gases to pass. Such a liner may be used to flow temperature-controlled air through the mattress to the patient to help control the patient's temperature. In some embodiments, the liner may further have non-permeable sides to better direct airflow up through the mattress.

In one embodiment of the seat foam insert 1902, the top side 1912 has a length of about 24.5 inches, the head-oriented sloped side 1914 has a length of about 21.6 inches, and the feet-oriented sloped side 1916 has a length of about 4.25 inches. The top side 1912 and the head-oriented sloped side 1914 together define an angle of about 7 degrees, the head-oriented sloped side 1914 and the feet-oriented sloped side 1916 together define an angle of about 128 degrees, and the feet-oriented sloped side 1916 and the top side 1912 together define an angle of about 45 degrees.

In one embodiment, the foam support 1800 has a thickness of about 9 to 10 inches. It will be appreciated that various modifications to the dimensions may be considered.

The top foam body section 1922 is made of a material that is adapted for conforming to the occupant's body with minimum pressure, while each of the base foam 1900 and the seat foam insert 1902 is made of a material that is adapted for supporting the patient's weight. Thus, to provide effective support the seat foam insert 1902 is denser than the material of the base foam 1900. For example, the seat foam insert 1902 is made of a material having a density of around between 2.25 and 2.75 lbs by square inches, preferably about 2.50 lbs by square inches, and having an indentation force deflection (25% IFD) of about between 8 and 15 lbs, preferably about 12 lbs. The base foam 1900 is made of a material having a density of around between 2.00 and 2.25 lbs by square inches, preferably about 2.15 lbs by square inches, and having an indentation force deflection (25% IFD) of about between 20 and 26 lbs, preferably about 23 lbs. The top foam body section 1922 is made of a material having a density of around between 2 and 4 lbs by square inches, preferably about 3 lbs by square inches, and having an indentation force deflection (25% IFD) of about between 20 and 22 lbs, preferably about 21 lbs. Exemplary material for the seat foam insert 1902, the base foam 1900, and the top foam body section 1922 includes polyurethane.

When an occupant lies on the foam support 1800, the occupant's weight is mainly supported by each of the base foam 1900 and the seat foam insert 1902. The inventors of the present invention have discovered that the structure of the foam support 1800 previously described enables to provide an enhanced distribution of the compression forces applied thereto by an occupant for preventing and/or minimizing skin wounds, pressure ulcers, and/or bedsores. More particularly, the slopped sides 1914, 1916 of the seat foam insert 1902 each distributes at least a portion of the downward force applied thereto by the weight of the occupant to adjacent portions of the base foam 1900. The density difference between the base foam 1900 and the seat foam insert 1902 also helps to enhance the distribution of the compression forces.

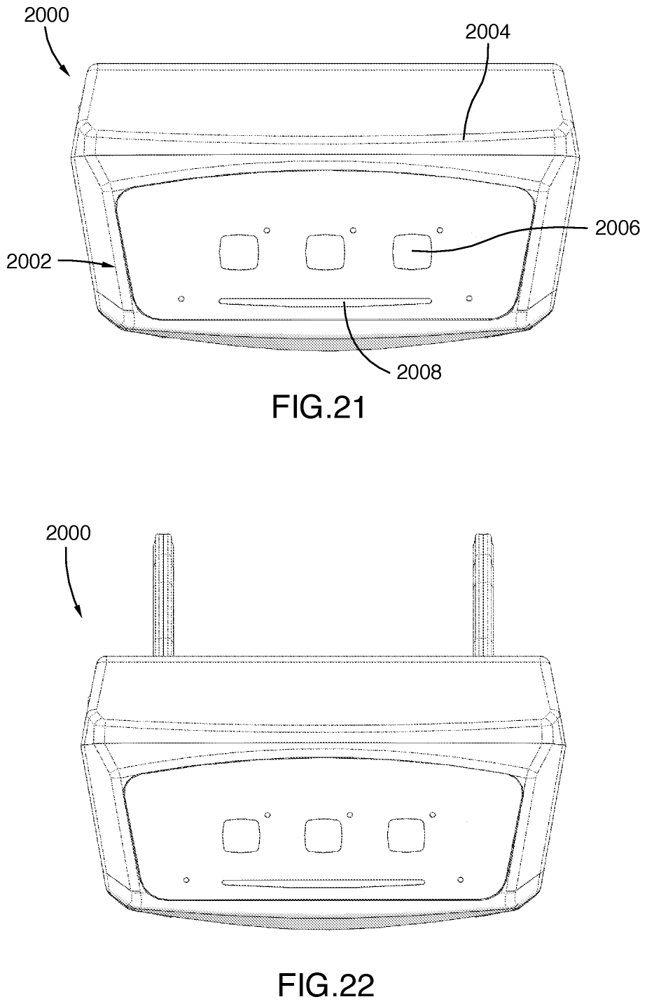

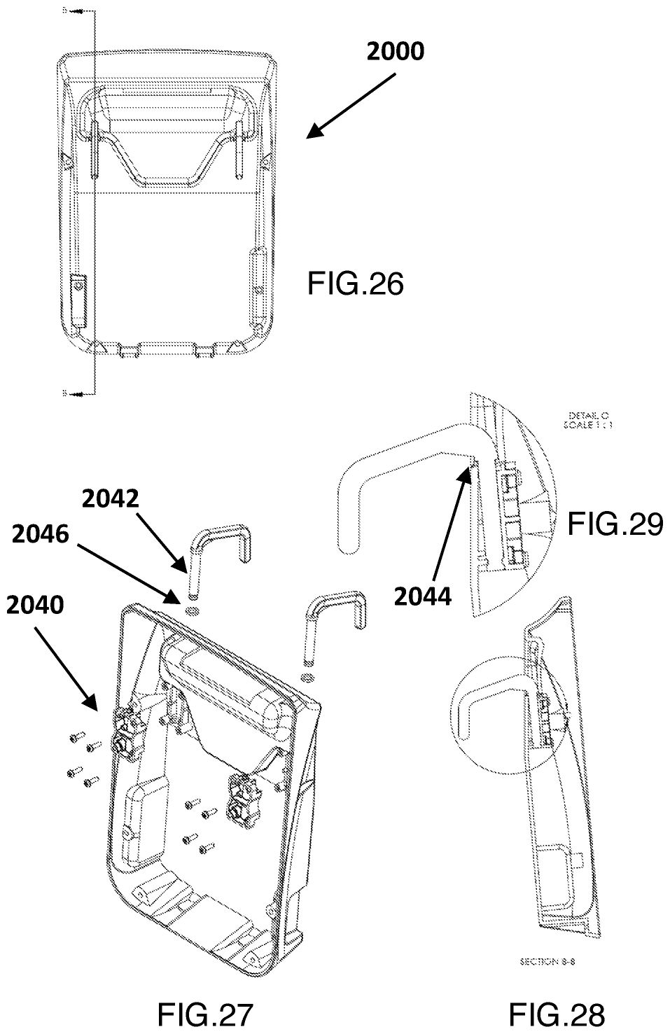

Reference is now made to FIG. 21 to 30 showing an air pump module 2000 that can be used with the microclimate management system 100 and the microclimate management overlay 900 previously described, according to one embodiment of a fourth aspect of the present disclosure. As better shown in FIGS. 21 and 22, the air pump module 2000 has a control panel 2002 on a top face 2004 thereof for controlling functions thereof. In the illustrated embodiment, the control panel 2002 has a on/off control button 2006 and is also provided with a status light indicator 2008 for indicating the status of the air pump module 2000. For example, under normal operation of the air pump module 2000, the status light indicator 2008 emits green light while it emits red light in case of a malfunction. When the air pump module 2000 is turned off, the status light indicator 2008 is off and no light is emitted. In one embodiment, the status light indicator 2008 is a thin elongated indicator providing visual feedback on the status of the air pump module 2000.

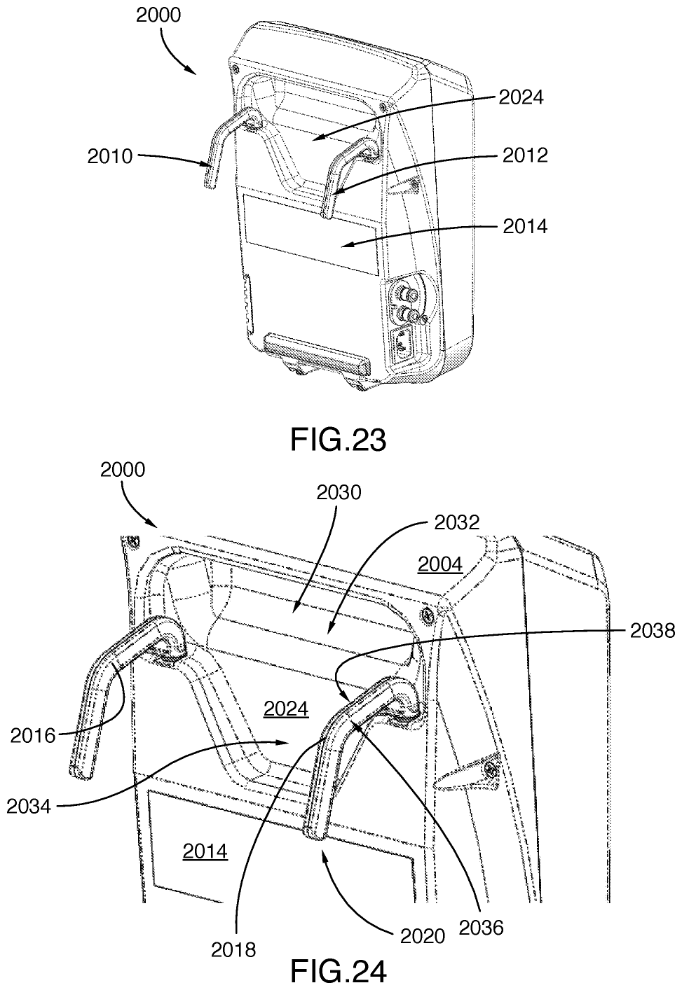

As better shown in FIG. 23, the air pump module 2000 has a substantially rectangular shape and is provided with two hooked hanging handles 2010, 2012 attached to the rear side 2014 of the air pump module 2000 and adapted to be installed on a barrier of the hospital bed on which it is used, as known in the art.

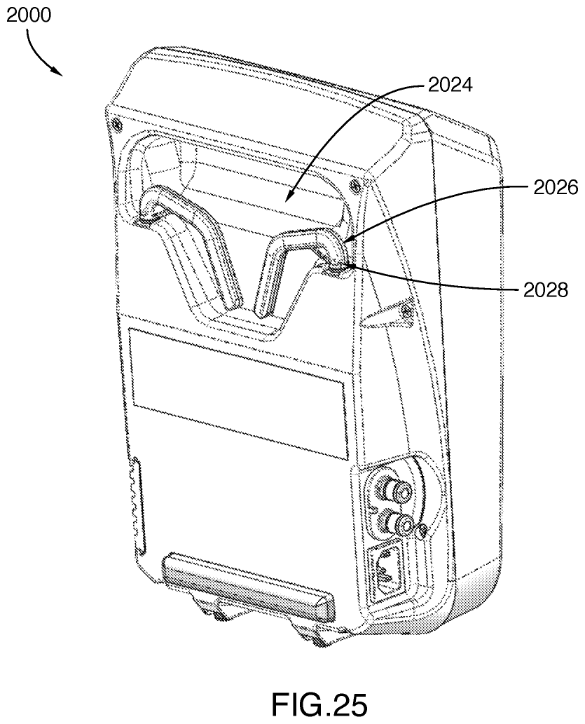

The hooked hanging handles 2010, 2012 may be pivoted laterally between a deployed operative position as illustrated in FIG. 23 wherein the hooked hanging handles 2010, 2012 project outwardly from the rear side 2014 to enable installation of the air pump module 2000 on the barrier and a stowed position, as illustrated in FIG. 25, wherein the hooked hanging handles 2010, 2012 extends against the rear side 2014.

In the illustrated embodiment, as better shown in FIG. 24, each hooked hanging handle 2010, 2012 has a substantially flat horizontal portion 2016 devised to rest on a portion of the barrier to which the air pump module 2000 is mounted. The substantially flat horizontal portion 2016 is slightly slopped downwardly at a distal end 2018 thereof. This slight slope enables to more easily guide the air pump module 2000 against the barrier in a rest position. Each hooked hanging handle 2010, 2012 also has a substantially vertical portion 2020 extending at the distal end 2018 of the substantially flat horizontal portion 2016 to prevent accidental removal of the air pump module 2000 from the barrier of the hospital bed which could occur during displacement of the hospital bed for example.

In the illustrated embodiment, a recess 2024 is provided in the rear side 2014 of the air pump module 2000 for receiving therein the hooked hanging handles 2010, 2012 when in the stowed position. Indeed, as better shown in FIG. 25, the recess 2024 has a predetermined depth that allow the two hooked hanging handles 2010, 2012 to be fully contained therein in the stowed position. Each hooked hanging handle 2010, 2012 is attached to the air pump module 2000 at its proximal end 2026 at a pivot point 2028 extending inside the recess 2024. This arrangement helps to reduce encumberment of the air pump module 2000 when not in use and facilitates an efficient storage and stacking of a plurality of air pump module 2000.

As better shown in FIG. 24, the recess 2024 provided in the rear side 2014 forms, with the top face 2004, an integrated transport handle 2030 that facilitates prehension of the air pump module 2000. In this illustrated embodiment, the upper portion 2032 of the recess 2024 has a first predetermined depth devised to facilitate prehension by a user. In other words, this depth should be configured to enable a user to easily insert his fingers therein for transport of the air pump module 2000. The lower portion 2034 of the recess 2024 has a second predetermined depth smaller than the first predetermined depth that is adapted to fully receive the stowed hooked hanging handles 2010, 2012.

In one embodiment, the hooked hanging handles 2010, 2012 are obtained by plastic molding processing. As better shown in FIG. 24, the substantially flat horizontal portion 2016 of each of the hooked hanging handles 2010, 2012 has a substantially rectangular cross section. More particularly, the top and bottom surfaces of the cross section are planar and horizontal while the two opposed side surfaces 2036, 2038 extending therebetween have a concave shape rounded inwardly. The inventors of the present invention have discovered that this particular shape may prevent any slight deformation that may arise during the drying step of the molding process.

FIGS. 27 to 30 show an attaching mechanism 2040 used to pivotally mount the hooked hanging handles 2010, 2012 to the air pump module 2000. As illustrated, the proximal portion 2042 of the hooked hanging handles 2010, 2012 are each mounted into a respective aperture 2044 provided in the recess 2024. The attaching mechanism 2040 is mounted inside the air pump module 2000 and is devised to receive and pivotally retain the hooked hanging handles 2010, 2012 therein. A seal 2046 is mounted around the proximal portion 2042 of the hooked hanging handles 2010, 2012 to provide an air pump module 2000 that is easy to clean.

Although various embodiments have been illustrated, this was for the purpose of describing, but not limiting, the invention. Various modifications will become apparent to those skilled in the art and are within the scope of this invention, which is defined more particularly by the attached claims.

The foregoing is considered as illustrative only of the principles of the invention. Since numerous modifications and changes will become readily apparent to those skilled in the art in light of the present description, it is not desired to limit the invention to the exact examples and embodiments shown and described, and accordingly, suitable modifications and equivalents may be resorted to. It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

Although the present invention has been described in considerable detail with reference to certain embodiments thereof, variations and refinements are possible and will become apparent to the person skilled in the art in view of the present description. The invention is defined more particularly by the attached claims.

1. A microclimate management system for an occupant support having an occupant receiving surface, the microclimate management system comprising:
a top layer disposable above the occupant receiving surface of the occupant support;
an intermediate air diffusion layer operatively interposable between the top layer and the occupant receiving surface of the occupant support; and
a bottom air distribution manifold mountable with the occupant support and having a plurality of air distribution conduits, each extending at least partially through the occupant support upwardly towards the occupant receiving surface for distributing air to the intermediate air diffusion layer, the plurality of air distribution conduits being arranged according to a predetermined pattern relative to the occupant receiving surface defining a microclimate managed area.

2. The microclimate management system of claim 1, wherein the top layer is moisture permeable.

3. The microclimate management system of claim 2, wherein the top layer has a moisture vapor transmission rate between about 50 g/m2/24 hrs and 600 g/m2/24 hrs when measured according to ASTM E96-00.

4. The microclimate management system of claim 2, wherein the microclimate management system is configured to remove moisture that permeates the top layer.

5. The microclimate management system of claim 1, wherein the air distributed to the intermediate air diffusion layer via the bottom air distribution manifold diffuses throughout the intermediate air diffusion layer.

6. The microclimate management system of claim 1, wherein the top layer is air permeable.

7. The microclimate management system of claim 6, wherein a substantial portion of the air distributed to the air distribution conduits is evacuated through the top layer.

8. The microclimate management system of claim 1, wherein the top layer is non-air permeable.

9. The microclimate management system of claim 1, wherein the top layer is removably connectable to the occupant support via at least one attachment element.

10. The microclimate management system of claim 9, wherein a substantial portion of the air distributed to the air distribution conduits is evacuated through the at least one attachment element.

11. The microclimate management system of claim 1, wherein the microclimate management system is configured to regulate at least one of a moisture content and a temperature in the microclimate managed area.

12. (canceled)

13. The microclimate management system of claim 1, wherein the air distribution conduits are arranged in at least two distant groups.

14. The microclimate management system of claim 13, wherein the at least two distant groups correspond to at least two microclimate managed areas.

15. The microclimate management system of claim 14, wherein the at least two microclimate managed areas correspond to distinct anatomical regions of the occupant.

16. The microclimate management system of claim 1, further comprising a bottom layer removably connectable to the top layer to form a compartment for enclosing the occupant support and the bottom air distribution manifold therein.

17. (canceled)

18. The microclimate management system of claim 1, further comprising a fluid-resistant envelope for enclosing the occupant support therein, the fluid-resistant envelope having a plurality of air circulation apertures, each being operatively connected to a corresponding one of the plurality of air distribution conduits.

19. The microclimate management system of claim 1, wherein the bottom air distribution manifold comprises an elongated air supply section disposed below the occupant support, the elongated air supply section being operatively connectable to each of the plurality of air distribution conduits.

20. The microclimate management system of claim 19, wherein the elongated air supply section comprises a three-dimensional spacer extending therein.

21. The microclimate management system of claim 1, wherein the intermediate air diffusion layer comprises at least one fabric.

22. The microclimate management system of claim 21, wherein the at least one fabric of the intermediate air diffusion layer exhibits a plurality of gas channeling features.

23-48. (canceled)
